(19) United States
(12) Patent Application Publication
(10) Pub. No.: US 2011/0047056 A1
(43) Pub. Date: Feb. 24, 2011

(54) CONTINUOUS MEASUREMENT AND INDEPENDENT VERIFICATION OF THE QUALITY OF DATA AND PROCESSES USED TO VALUE STRUCTURED DERIVATIVE INFORMATION PRODUCTS

(76) Inventors: Stephen Overman, Renton, WA (US); Geoffrey S.L. Shaw, Scottsdale, AR (US)

Correspondence Address: GREENBERG TRAURIG, LLP, MET LIFE BUILDING, 200 PARK AVENUE, NEW YORK, NY, 10166, US

(21) Appl. No.: 12/577,692

(22) Filed: Oct. 12, 2009

Related U.S. Application Data
(60) Provisional application No. 61/195,836, filed on Oct. 11, 2008.

(51) Int. Cl. G06Q 40/00

(52) U.S. Cl. 705/35

(57) ABSTRACT

One embodiment of the present invention relates to a system for measurement and verification of data related to at least one financial derivative instrument, wherein the data related to the at least one financial derivative instrument is associated with at least a first financial institution and a second financial institution, and wherein the first financial institution and the second financial institution are different from one another.

### RELATED APPLICATIONS

This application claims the benefit of U.S. Provisional Application Ser. No. 61/195,836, filed Oct. 11, 2008. The aforementioned application is incorporated herein by reference in its entirety.

### FIELD OF THE INVENTION

In one example, measurement (e.g., continuous measurement) and/or verification (e.g., independent verification) of the quality of data and/or processes used to value one or more products (e.g., one or more structured derivative information products) may be provided.

### BACKGROUND OF THE INVENTION

One embodiment of the present invention relates to a system for measurement and verification of data related to at least one financial derivative instrument, wherein the data related to the at least one financial derivative instrument is associated with at least a first financial institution and a second financial institution, and wherein the first financial institution and the second financial institution are different from one another.

### BRIEF DESCRIPTION OF THE DRAWINGS

FIGS. 1-8 show block diagrams related to various data provenance examples according to embodiments of the present invention.

FIGS. 9-12 show block diagrams related to various mortgage backed securities/asset backed securities examples according to embodiments of the present invention.

FIG. 13 shows block diagram related to a policy example according to an embodiment of the present invention.

FIGS. 14-16 show block diagrams related to various business examples according to embodiments of the present invention.

FIG. 17 shows a block diagram related to a trusted data exchange example according to an embodiment of the present invention.

FIGS. 18-25 show block diagrams related to various model/simulation examples according to embodiments of the present invention.

FIG. 26 shows a block diagram related to a policy example according to an embodiment of the present invention.

FIGS. 27-29 shows block diagrams related to model/simulation examples according to embodiments of the present invention.

FIG. 30 shows a block diagram related to a high-level abstraction example according to an embodiment of the present invention.

FIG. 31 shows a block diagram related to a client framework development tools example according to an embodiment of the present invention.

FIGS. 32-33 shows block diagrams related to a “Perspective Computing” example according to embodiments of the present invention.

FIGS. 34-37 show block diagrams related to various tracking/license manager examples according to embodiments of the present invention.

FIG. 38 shows a block diagram related to a “Perspective Computing” services life cycle example according to an embodiment of the present invention.

FIGS. 39-50 show block diagrams related to various business capability exploration examples according to embodiments of the present invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION OF THE INVENTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive. Further, the figures are not necessarily to scale, some features may be exaggerated to show details of particular components (and any data, size, material and similar details shown in the figures are, of course, intended to be illustrative and not restrictive). Therefore, specific structural and functional details disclosed herein are not to be interpreted as limiting, but merely as a representative basis for teaching one skilled in the art to variously employ the present invention.

In one embodiment, a system for measurement and verification of data related to at least one financial derivative instrument, wherein the data related to the at least one financial derivative instrument is associated with at least a first financial institution and a second financial institution, and wherein the first financial institution and the second financial institution are different from one another is provided, comprising: at least one computer; and at least one database associated with the at least one computer, wherein the at least one database stores data relating to at least: (a) a first quality of the data metric related to the at least one financial derivative instrument, wherein the first quality of data metric is associated with the first financial institution (in various examples, the first quality of data metric may be input by the first financial institution (e.g., one or more employees and/or agents); the first quality of data metric may be made by the first financial institution (e.g., one or more employees and/or agents); and/or the first quality of data metric may be verified by the first financial institution (e.g., one or more employees and/or agents)); and (b) a second quality of the data metric related to the at least one financial derivative instrument, wherein the second quality of data metric is associated with the second financial institution (in various examples, the second quality of data metric may be input by the second financial institution (e.g., one or more employees and/or agents); the second quality of data metric may be made by the second financial institution (e.g., one or more employees and/or agents); and/or the second quality of data metric may be verified by the second financial institution (e.g., one or more employees and/or agents)); wherein the at least one computer is in operative communication with the at least one database; and wherein the at least one computer and the at least one database cooperate to dynamically map a change of the quality of the data, as reflected in at least the first data metric and the second data metric.

In one example, the measurement and verification of data may relate to a plurality of financial derivative instruments.

In another example, the financial derivative instrument may be a financial instrument that is derived from some other asset, index, event, value or condition.

In another example, each of the first and second financial institutions may be selected from the group including (but not limited to): (a) bank; (b) credit union; (c) hedge fund; (d) brokerage firm; (e) asset management firm; (f) insurance company.

In another example, a plurality of computers may be in operative communication with the at least one database.

In another example, the at least one computer may be in operative communication with a plurality of databases.

In another example, a plurality of computers may be in operative communication with a plurality of databases.

In another example, the at least one computer may be a server computer.

In another example, the dynamically mapping may be carried out essentially continuously.

In another example, the dynamically mapping may be carried out essentially in real-time. In another example, the system may further comprise at least one software application.

In another example, the at least one software application may operatively communicate with the at least one computer.

In another example, the at least one software application may be installed on the at least one computer.

In another example, the at least one software application may operatively communicate with the at least one database.

In another example, the system may further comprise a plurality of software applications.

In another example, the computing system may include one or more programmed computers.

In another example, the computing system may be distributed over a plurality of programmed computers.

In another example, any desired input (e.g., data input) may be made (e.g. to any desired computer and/or database) by one or more users (e.g., agent(s) and/or employee(s) of one or more financial institution(s); agent(s) and/or employee(s) of one or more other institution(s); agent(s) and/or employee(s) of one or more third party or parties).

In another example, any desired output (e.g., data output) may be made (e.g. from any desired computer and/or database) to one or more users (e.g., agent(s) and/or employee(s) of one or more financial institution(s); agent(s) and/or employee(s) of one or more other institution(s); agent(s) and/or employee(s) of one or more third party or parties).

In another example, any desired output may comprise hardcopy output (e.g., from one or more printers), one or more electronic files, and/or output displayed on a monitor screen or the like.

In another example, mapping a change of quality of data may be carried out over time.

In another example, mapping a change of quality of data may comprise outputting one or more relationships and/or metrics.

In another example, mapping a change of quality of data may be done for one or more “networks” (e.g., a network of financial institutions, a network of people, a network of other entities and/or any combination of the aforementioned parties).

In another example, a “network” may be defined by where a given instrument (e.g., financial instrument) goes.

In another example, a “network” may be defined by the party or parties that own (at one time or another) a given instrument (e.g., financial instrument).

In another example, a “network” may be discovered by contract or the like.

In another example, as a financial institution (e.g., a bank) begins to trade in derivatives (e.g., with one or more default contracts) so-called PERSPECTACLES according to various embodiments of the present invention may show transparency.

In another example, one or more computers may comprise one or more servers.

In another example, a first financial institution may be different from a second financial institution by being of a different corporate ownership (e.g. one financial institution may be a first corporation and another (e.g., different) financial institution may be a second corporation).

In another example, a first financial institution may be different from a second financial institution by being of a different type (e.g. one financial institution may be of a bank type and another (e.g., different) financial institution may be of an insurance company type). In another example, a financial derivative instrument may comprise debt.

In another embodiment a method performed in a computing system may be provided.

In one example, the computing system used in the method may include one or more programmed computers.

In another example, the computing system used in the method may be distributed over a plurality of programmed computers.

In another embodiment one or more programmed computers may be provided. In one example, a programmed computer may include one or more processors.

In another example, a programmed computer may be distributed over several physical locations.

In another embodiment a computer readable medium encoded with computer readable program code may be provided.

In one example, the program code may be distributed across one or more programmed computers.

In another example, the program code may be distributed across one or more processors. In another example, the program code may be distributed over several physical locations. In another example, any communication (e.g., between a computer and an input device, between or among computers, between a computer and an output device) may be uni-directional or bi-directional (as desired).

In another example, any communication (e.g., between a computer and an input device, between or among computers, between a computer and an output device) may be via the Internet and/or an intranet.

In another example, any communication (e.g., between a computer and an input device, between or among computers, between a computer and an output device) may be carried out via one or more wired and/or one or more wireless communication channels

In another example, any desired number of computer(s) and/or database(s) may be utilized.

In another example, there may be a single computer (e.g., server computer) acting as a “central server”. In another example, there may be a plurality of computers (e.g., server computers), which may act together as a “central server”.

In another example, one or more users (e.g., one or more employees of one or more financial institutions, one or more agents of one or more financial institutions, one or more third parties) may interface (e.g., send data and/or receive data) with one or more computers (e.g., one or more computers in operative communication with one or more databases containing relevant data) using one or more web browsers.

In another example, each web browser may be selected from the group including (but not limited to): INTERNET EXPLORER, FIREFOX, MOZILLA, CHROME, SAFARI, OPERA. In another example, any desired input device(s) for controlling computer(s) may be provided for example, each input device may be selected from the group including (but not limited to): a mouse, a trackball, a touch=sensitive surface, a touch screen, a touch sensitive device, a keyboard).

In another example, various embodiments of the present invention may comprise a hybrid of a distributed system and central system.

In another example, various instructions comprising “rules” and/or algorithms may be provided (e.g., on one or more server computers).

In another example (related to liquid trust-financial MBS business domain), practical line grained control of macro-prudential regulatory policy as “Perspectacles” may be provided this may relate, in one specific example, to operational business processes and policies. Further, various “discriminators” associated with various software systems capabilities may be provided in other examples as follows: Perspectacles™; Situation Awareness of Complex Business Ecosystems; Data Provenance; Continuous Policy Effectiveness Measurement; Continuous Risk Assessment; Continuous Audit; Policy Control Management; and/or IP Value Management.

In another example, a new generation of LiquidTrust MBS Synthetic Derivatives may be provided.

For the purposes of this disclosure, a computer readable medium is a medium that stores computer data/instructions in machine readable form. By way of example, and not limitation, a computer readable medium can comprise computer storage media as well as communication media, methods or signals. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to tangibly store the desired information and which can be accessed by the computer.

Further, the present invention may, of course, be implemented using any appropriate computer readable medium, computer hardware and/or computer software. In this regard, those of ordinary skill in the art are well versed in the type of computer hardware that may be used (e.g., one or more mainframes, one or more mini-computers, one or more personal computers (“PC”), one or more networks (e.g., an intranet and/or the Internet)), the type of computer programming techniques that may be used (e.g., object oriented programming), and the type of computer programming languages that may be used (e.g., C++, Basic). The aforementioned examples are, of course, illustrative and not restrictive.

Of course, any embodiment/example described herein (or any feature or features of any embodiment/example described herein) may be combined with any other embodiment/example described herein (or any feature or features of any such other embodiment/example described herein).

While a number of embodiments/examples of the present invention have been described, it is understood that these embodiments/examples are illustrative only, and not restrictive, and that many modifications may become apparent to those of ordinary skill in the art. For example, certain methods may be “computer implementable” or “computer implemented.” Also, to the extent that such methods are implemented using a computer, not every step must necessarily be implemented using a computer. Further, any steps described herein may be carried out in any desired order (and any steps may be added and/or deleted).

In another example, the present invention may provide for adequate transparency and management oversight of overly complex products. In another example, the present invention may provide a mechanism for institutional responsibility and management accountability.

In another example, the present invention may provide mechanisms for revaluing and unwinding large inventories of troubled securities and corresponding credit default swap contracts. In another example, the present invention may take into consideration the sensitivity of bank portfolio valuation and pricing assumptions. In another example, the present invention may provide a common valuation approach without exposing the entire financial system to new vulnerabilities.

In another example, the present invention may provide a mechanism for effectively assessing risks associated with certain derivative information products packaged as structured investment vehicles, and independently verifying the quality of the data underpinning those instruments.

In another example, the present invention may provide a consultative model of a policy compliance risk assessment technology, referred herein as GRACE-CRAFT. In another example, GRACE may stand for Global Risk Assessment Center of Excellence. In another example, CRAFT may stand for five key attributes of the enabling risk assessment technology: Consultative, Responsibility, Accountability, Fairness, and Transparency.

In another example, the GRACE-CRAFT model of the present invention is a consultative model of a flexible mechanism for continuously and independently measuring the effectiveness of risk assessments of compliance with polices governing, among other things, data quality from provider and user perspectives, business process integrity, derivative information product quality, aggregation, distribution, and all other aspects of data use, fusion, distribution and conversion in information, material, and financial supply and value chains. In another example, the CRAFT mechanism is designed to provide a consistent, repeatable, and independently verifiable means of quantifiably assessing the degree of compliance with policies governing simple and complex relationships between specific policies and the processes, events and transactions, objects, persons, and states of affairs they govern.

In another example, the inventive model provides for processes, events, objects, persons, and states of affairs to be organized by individuals and organizations into systems to do things. In another example, the inventive model assumes that what those things are, and how they are accomplished is a function of the policies individuals and organizations define and implement to govern them.

In another example, GRACE CRAFT applications consist of collections of related polices called ontologies, and business processes that manage the relationships between these policies and the objects (including data and information products), events (including transactions), processes (including business processes as well as mechanical, electronic and other types of processes), persons (individual and corporate), and states of affairs that the policies govern. In another example, the inventive GRACE CRAFT model provides a consistent, and independently verifiable, e.g., transparent, means of assessing the relative effectiveness of alternative polices intended to produce or influence specific behaviors.

In another example, GRACE-CRAFT applications can support a high degree of complexity. In another example, the inventive model enables the quality and provenance of all data and derivative products, and the integrity of every process called by applications, to be continuously and independently verified. In another example, the inventive model provides a mechanism, and the transparency inherent in it, that effects change—anticipated or not—on assumptions underpinning policies, and on the data, processes, persons, and the relationships governed by those policies, which are clearly visible and retained for future analysis.

In another example, the model of the GRACE-CRAFT mechanism is intended to provide users with a clear view into complex relationships between the objects, events, processes, persons and states of affairs that might comprise a systems application. In another example, the inventive model allows for discovering how different assumptions related to asset pricing might change over time, for example. In another example, the inventive model allows for examining how various assumptions might be represented in policies that govern data quality and other system requirements.

In another example, the inventive model provides for 1 modeling existing derivative information products to discover and examine various assumptions, data quality metrics, and other attributes of the products that might not be readily apparent to buyers—or sellers. In another example, the inventive model supports retrospective discovery and analysis of derivative product pricing and valuation assumptions, and evaluating alternatives intended to reflect current conditions and policy priorities. In another example, the GRACE-CRAFT model and its underlying systems technology are equally applied to examine assumptions underpinning other data and process dependent business and scientific conclusions.

In another example, the inventive GRACE-CRAFT model provides a consistent modeling and experimentation mechanism for assuring continuous and independently verifiable compliance with policies governing high value data and information exchanges between government, industry and academic stakeholders engaged in complex global supply chain and critical infrastructure operations. In another example, the inventive model accounts for long term strategic frameworks spanning virtually all domains of knowledge discovery and exploration as well as international legal and policy jurisdictions and environments. In another example, the inventive model may be capable of dealing with dynamic change; and they must support continuous independent verification of multiple confidence building measures and transparency mechanisms underpinning trusted exchange of sensitive high value data and derivative information.

In another example, the inventive GRACE-CRAFT modeling approach recognizes that multiple, and often conflicting and competing policies will be used by different stakeholders to measure data quality, assess related risks, and govern derivative product production and distribution. In another example, the inventive model recognizes and anticipates that these policies will change over time as the environment they exist in changes and stakeholder priorities change.

From our perspective, this type of dynamic and ongoing change is normal, to be expected, and better planned for than ignored.

In another example, the inventive model provides for ability to consistently measure and independently verify the effectiveness of various polices, regardless of what institution makes them, so that their relative merits and defects can be as confidently and transparently evaluated as the information products and processes they seek to govern. In another example, the inventive model is capable of detecting and measuring the impact of whatever intended and unintended policy consequences result.

An Example of the GRACE-CRAFT Model

The GRACE-CRAFT model of this example is a consultative model. As such its function is to guide, not to dictate; to illuminate assumptions, assertions, and consequences. The exemplary GRACE-CRAFT model is intended to support efficient simulation and assessment of the effectiveness of polices governing, among other things, data quality and processes used to create, use, and distribute data and derivative products to do work. The exemplary GRACE-CRAFT model can be used to track data provenance through generations of derivative works. Data provenance tracing and assurance is a key concept and functional capability of this model and the application mechanism it supports. Not being able to assess and verify the data provenance of derivative structured investment products is the fatal flaw of collateralized debt and credit swap instruments created prior to 2008. We maintain that data provenance assurance is critical to identifying and understanding how derivative product quality, value, and pricing will change over time.

Finally, we describe how the model supports continuous policy compliance. This objective function provides measurable feedback to agents and enables them to make adjustments to the policies and processes affecting their objectives. These objectives endure continuous state changes as the environment in which they exist morphs to reflect evolving relationships between the changing objects, persons, events, processes, and states of affairs that exist in it and that it consists of. The exemplary GRACE-CRAFT model by performing continuous policy compliance assurance provides independent feedback to agents to support adjusting to changing conditions as their environment and priorities evolve, and that this is a critical requirement because change is, indeed, the one certainty agents can count on. In accordance with the exemplary GRACE-CRAFT model agents can now count on two others: 1) that they can continuously and independently model the effects of change on their world view (Weltanschauung), the epistemological framework which supports their assumptions, policies and view of their world and their place in it, and 2) that they can continuously improve the results of their models by continuously and independently assessing and verifying the quality of the data they use to support their world view model(s).

The exemplary GRACE-CRAFT model and the comprehensive policy compliance risk assessment mechanism it supports can accelerate establishing trust in business relationships by providing a consistent mechanism for continuously and independently verifying the basis for that trust. The exemplary GRACE-CRAFT model provides for verifying and validating the basis of trust as defined by a given market, thus allowing its users to define and enforce a consistent ethic to sustain the market and its participants.

As an example, one can use supply chain and Bill of Materials analogies. In doing so, the exemplary GRACE-CRAFT model draws on ongoing work on two programs that share an underlying problem structure. One program focuses on continuous optimization and risk assessment for global intermodal containerized freight flow and supply chain logistics (The Intermodal Containerized Freight Security Program, ICFS). The ICFS program is funded by industry participants and the US Department of Transportation. The ICFS program is managed by the University of Oklahoma, College of Engineering. It is a multidisciplinary research and development program with researchers in public and corporate policy, business process, accounting and economics, computer science, sensor and sensor network design, ethics and anthropology. Participating colleges and universities include the college of Business and Economics and the Lane Dept. of Computer Science at West Virginia University, and the Wharton Center for Risk Management and Decision Processes at the University of Pennsylvania. Lockheed Martin Maritime and Marine Systems Company, VIACK Corporation, and the Thompson Advisory Group are among the industry sponsors.

The other program is the GRACE-National Geospatial-Intelligence Agency Climate Data Exchange Program. This program is a global climate data collection, exchange, and information production and quality assurance program funded by industry participants and the National Geospatial Intelligence Agency (NGA). The GRACE-NGA Climate Data Exchange Program is managed by the GRACE research foundation. Participating colleges, universities and research centers include those mentioned above as well as the Center for Transportation and Logistics at MIT, the Georgia Tech Research Institute, the University of New Hampshire Institute for the Study of Earth Ocean Space, Lockheed Martin Space Systems Company, Four Rivers Associates and others.

The GRACE-NGA Climate Data Exchange program tests policy-centric approaches to enhancing the capacity, operational effectiveness and economic efficiency of industry, government, and academic data collection and distribution missions and programs. In the exemplary GRACE-CRAFT model, a central activity of the program is the design, construction, testing and validation of robust ontologies of policies governing virtually all stakeholder-relevant aspects of data collection infrastructure and supply chain quality. This includes cradle to grave data provenance and quality assurance, proprietary data and derivative product production, protection and management, data and derivative product valuation and exchange process validation and quality assurance, and other requirements of supporting enterprise and collaborative data collection and analysis operations. As such, participation in this program might provide useful and timely policy representation and ontology implementation experience to financial industry and regulatory stakeholders.

### An Example of Applying the Inventive Grace-Craft Model to Subprime Mortgage Derivatives

In another example, the inventive model supports independent data quality, provenance, and process transparency validation.

In another example, the inventive model allows sell-side producers and buy-side managers to readily and independently validate the quality of the data and processes used to create derivative information products being traded after they were originally packaged. In another example, the inventive model provides for supply chain transparency. In another example, the inventive GRACE CRAFT model includes a utility function that operates as a provenance recording and query function and tracks the provenance of any type of data from cradle to grave. In another example, the inventive model includes, the essential elements of data provenance consist of who, when, where, how, and why. The essential unifying element of what is defined by the policy ontology that governs the relationship between these six essential elements of provenance.

Of particular importance to market agents, the GRACE-CRAFT provenance recording function captures and stores changes in state of all attributes and sets of attributes of events which enables changes in data quality, for instance, to be identified when it occurs. This kind of transparency enables agents to more effectively assess risk and more efficiently manage uncertainty. Some might think of the GRACE-CRAFT provenance recording/query utility as analogous to a compass, and the corresponding policy ontology as a map. These are useful tools to have when one is uncertain of where one might be in a wilderness.

In another example, the inventive model provides for provenance of a structured investment product, assessing its quality. If one is relying on a “trusted” third party (who) to attest to the quality associated with a product one buys, and large sums are at stake, one should explicitly understand the basis of that trust (how and why) and be able to continuously verify the third party's ability to support it (who, when, how, why, where, and what). These are relatively simple elements and policies to understand and capture in an ontology governing a relationship between a buyer and a seller. One might think of that ontology as a type of independently and continuously verifiable business assurance policy.

In another example, the inventive model is able to continuously measure and independently verify the quality of component data and processes used to create complex structured derivative products provides rational support for markets and market agents; even as original assumptions and conditions change—which is both natural and inevitable. Not being able to do this will inevitably create Knightian risk and market failures, described in Caballero, J. Ricardo and Arvind Krishnamurthy, Collective Risk Management in a Flight to Quality, Journal of Finance, August, 2007, incorporated herein in its entirety. Market agents are typically out to serve their own interests first. They and other market stakeholders benefit when the quality of a market agent's data and the integrity of the processes used to convert that data to market valuation information, can be continuously and independently measured and validated.

In another example, the inventive GRACE-CRAFT model supports retrospective data quality analysis to support rational value and pricing negotiations between buyers and sellers in markets that have been disrupted or distorted by inadequate transparency and mandated mark-to-market asset valuation accounting rules. In another example, the inventive GRACE-CRAFT model e defines ontologies that reflect buyer and seller best current understandings of the data and process attributes associated with products they are willing to trade if a suitable price can be discovered.

In another example, the inventive GRACE-CRAFT-NGA Climate Data program provides a suitable venue for financial industry stakeholders to learn how to do it quickly and efficiently. In another example, the inventive GRACE-CRAFT model supports the integration of stakeholder defined ethics that can be transparently applied, independently assured, and consistently enforced.

Effective risk management decisioning is strongly correlated to the quality of information products. These decisions impact the cost of capital, agent cash flows and liquidity choices, and other financial market efficiencies. In another example, the inventive GRACE-CRAFT model is able to identify or track changes in state affecting the quality of data used to assess risk. In another example, the inventive GRACE-CRAFT model is able to identify and track how a change of state to one element of data affects the other elements and the relationships between elements. In another example, the inventive GRACE-CRAFT model helps to avoid Knightian risk perceptions, flight to quality, and diminished liquidity in financial markets. These problems can create solvency and other serious challenges in the real economies that depend on these markets. Knightian risk, coupled with mark-to-market valuation mandates, is a witch's brew that rapidly creates derivative fear and uncertainty across interconnected sectors of the financial community and real economy. When coupled with mark-to-market pricing mandates, the reduced liquidity attendant to Knightian risk can evolve quickly into cascading solvency issues. Peloton and Bear Sterns are examples. In another example, the inventive GRACE-CRAFT model 1 provides a rational, consistent, continuous, and independently verifiable mechanism for managing Knightian risk and overcoming the deficiencies of mark-to-market pricing in Knightian market conditions.

In another example, the inventive GRACE-CRAFT model supports a setting in which sell-side firms report their risk assessment metrics, analysis, and other valuation reasoning to the market. In another example, the inventive GRACE-CRAFT model provides for reporting that can be direct or via trusted agencies to safeguard competitive and other proprietary interests. In another example, the inventive GRACE-CRAFT model allows buy-side managers in this setting to independently assess and validate reported reasoning and, if they wish, counter with their own. In such a setting, when a trade is completed the established market value reflects both firms' reports back to the market. The quality of the reports, which includes independent assessment and verification, affects investment risk management decisioning. This, in turn, affects expected cash flows, cost of capital, and liquidity opportunities. This setting supports the notions that reporting to capital markets play a crucial role in allocating capital and that the quality of information affects an agent's future net cash flows and capital liquidity opportunities.

In another example, the inventive GRACE-CRAFT model has two prime utility functions called Data Process Policy and Data Provenance respectively. These two objective functions drive what we call “Data Process Policy Driven Events” that enable agents to define specific attributes of quality, provenance, etc. that the agent asserts the data to possess. The CCA-CRAFT Software Service Suite 7 will audit for these attributes of the original data and track them as they are inherited by derivative products produced with that data. As the quality of the data changes over time, represented by measurable state changes in the attributes, so will the quality of the derivative.

In another example, the inventive GRACE-CRAFT model has a third function, a metric function, that is called the GRACE-CRAFT Objective function. This function conducts continuous measurement of data quality and provides agents with independent verification of the effectiveness of risk assessments of compliance with polices governing events, processes, objects, persons, and states of affairs in capital liquidity markets. In another example, the inventive GRACE-CRAFT reduces the uncertainty of data and derivative product quality by providing a consistent mechanism for continuously assessing that risk and independently verifying the effectiveness of those assessments.

In another example, the GRACE-CRAFT consultative model can accelerate establishing trust in business relationships by providing a consistent mechanism for continuously and independently verifying the basis for that trust. To the degree that one can accelerate establishing trusted relationships, one can accelerate the flow of ideas, capital and other resources to exploit those ideas, create new knowledge, and broaden the market for ideas, products and services that the market values. To the degree one can continuously verify and validate the basis of trust as defined by a given market, one can define and enforce a consistent ethic to sustain the market and its participants.

In another example, the inventive GRACE-CRAFT model uses the context of a financial liquidity market where agents produce and consume information in order to conduct risk assessments and make risk management decisions and investments. Within this context, the model uses a semantic ontology as the framework to build our model. The ontology describes a vocabulary for interactions of events, processes, objects, persons, and states of affairs. The exchange of information is represented as linked relationships between entities (producers and consumers of information) and described using knowledge terms called attributes which are dependent on state^{s}. These attributes define the semantic meaning and relationship interconnections between surrounding entity neighbors. The model ontology may also include policies that are used to enforce rules and obligations governing the behavior of interactions (events) between entities belonging to the model ontology. Events are described as the production and exchange of information, i.e., financial information (data and knowledge). In the context of a financial liquidity market, the model may assume that agents exchange information to support effective risk assessments and improve the efficiency of risk management decisions and investments.

### Another Example of the Consultative Model: A Semantic Ontology Approach

Some Definitions:

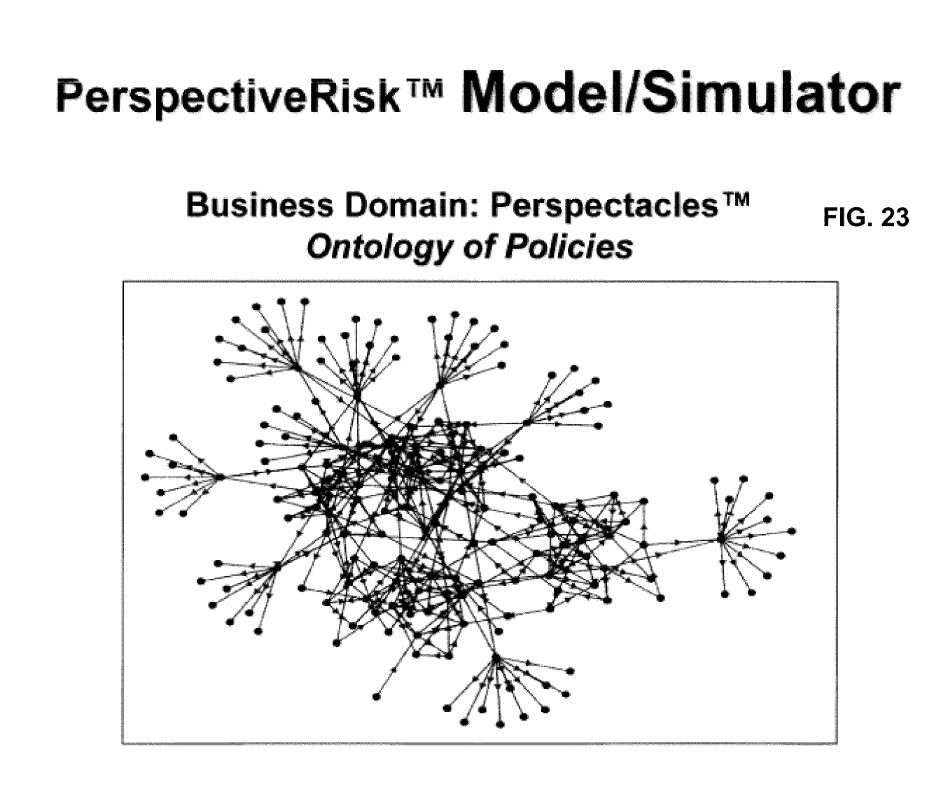

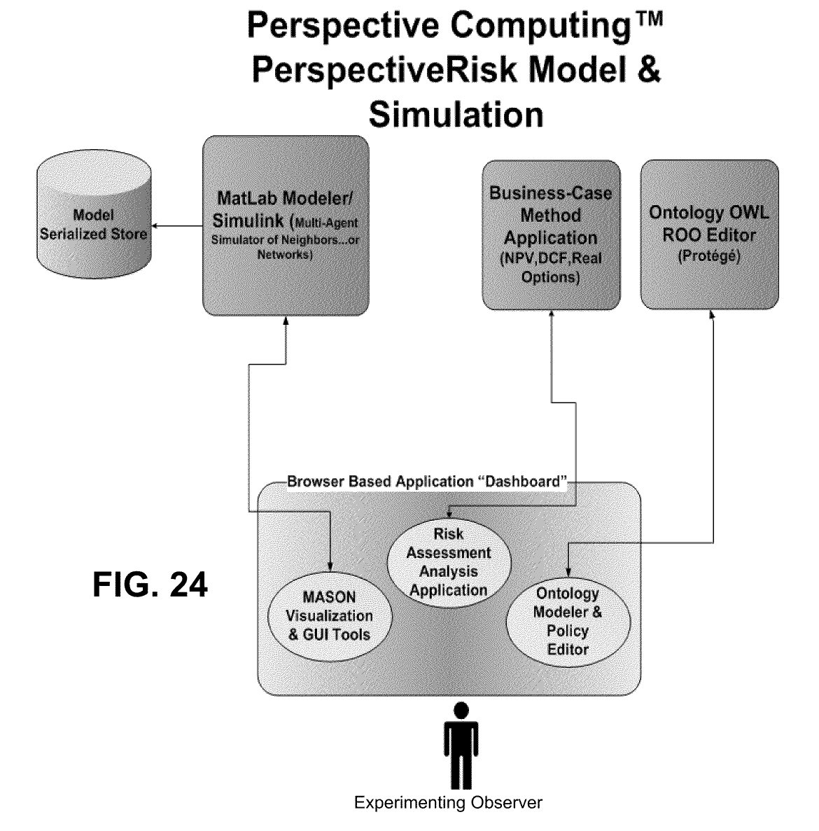

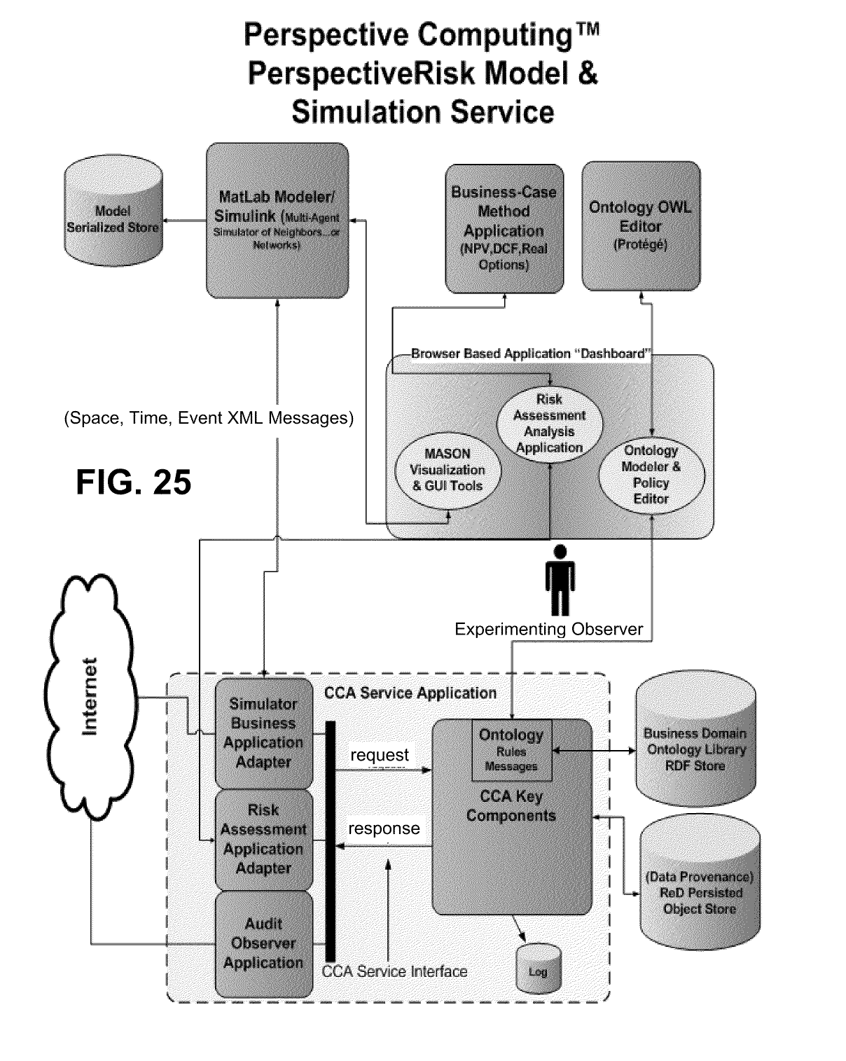

the ontology defined by Φ is the domain ontology representation for any particular business domain and can be described semantically in terms of classes, attributes, relations, instances. In another example, the inventive GRACE-CRAFT model uses the Semantic definition of ontology as described by Hendler, J., Agents and the Semantic Web, IEEE Intelligent Systems Journal, April 2001, incorporated herein in its entirety. The ontology may include t is a set of knowledge terms, including the vocabulary, the semantic interconnections and some simple rules of inference and logic, for some particular topic. A graphical domain ontology is represented, for example, in FIG. 23.

An entity (ν) is defined as ν ε Φ and is uniquely distinguishable from other entities in Φ. Entities can be thought of as nouns or objects in a domain of interest. Entities are semantically defined by an attribute set A=[α₁ . . . αₙ] and are the properties or predicates of an object and can change over time due to state changes in v. The existence or delineation of attributes can also be driven by the outcomes of predictable and unpredictable events in time that operate on all entities.

An agent (ω) is an entity where (ω⊂ν) that has a need to make effective risk management decisioning based upon measurably effective risk assessments. An agent can be characterized as a producer, consumer or prosumer of derivative informational products for purposes of conducting measurably effective risk management for purposes of effective risk management decisioning. It is assumed that any given agent seeks information of measurable high quality but the market does not provide such efficiencies in most cases.

An event (ε), [ε]=f(ω), in the context of the model is an action that is data process policy driven. Events act on the states of other events, processes, objects, persons and states of affairs. We require, for purposes of this model, that events are trackable. We discuss mechanisms that meet this requirement later in this document. Events are based on the information lifecycle of data and with a lifecycle of events: creation, storage, review, approval, verification, access, archiving, and deletion. Events are collectively described as:

Where—location where an event happens

When—the time when an event occurs

Who—the people or organizations involved in data creation and transformation

How—documents actions upon the data. These actions are labeled as data processes. It describes the details of how data has been created or transformed.

Which—describes the instruments or software applications used in creating or processing the data.

Why—decision making rational of actions.

A State (S),S=f(α, β, ε) where functions α, β act on the attributes of a set of entities and their corresponding relational attributes to other entities respectively. These special functions are described in more detail later. Attributes are used to describe data and therefore are themselves data. A change in state reflects a change in the data that describes data acted upon by certain events. A single event can change unique set of attributes therefore changing the semantic meaning of any set of Events, processes, objects, persons and states of affairs as defined in an ontology. This change is described as a state.

To simplify our model we use a directed acyclic graph representation of a subset of members of a semantically described ontology where the subset is defined by G⊂Φ where Φ is the domain ontology representation for any particular business domain or community of interest and can be described semantically as classes, attributes, relations, instances.

Events in Φ are defined as data process policy driven and can be synchronous and/or asynchronous. In Φ it is assumed that all business domain agents produce and consume data both synchronously and asynchronously for reasons of utility. We examine the subset G to simplify a mapping of events over a known time frame in order to simplify the model. Policies are used to govern behavior of data processes or other events on data. A policy set is evaluated based upon current state of the entities although during decisioning the state of the attributes of data can change and are captured in the model. We assume the physical nature of data can change in time and metadata used to track data provenance can change in state over time, but state changes in both can be mutually independent and are driven by recordable events.

The logical knowledge terms, the attributes, and the semantic interconnections of relations for a subset G in Φ can be used to describe a semantic topology of event paths driven by data process policy events and will be represented here as G where: To develop the model we create conditions that assist in simplifying our model's construct as we build in real world behaviors into the sub-ontology C.

First we define Condition (1.) for our model development as,

$$Condition ( 1. ) \text{:} \frac{\partial G}{\partial ɛ} = 0 ⇒ s = f ( α , β )$$

Condition (1.) defines the rate of change of state for the sub-ontology G with respect to change in event as equivalent to zero. This implies that the state in G is a function of the entropy functions α and/1 respectively. Therefore our model is not influenced by any known events based upon the condition declaration. Then we can say our directed acyclic graph representation is operated on by the function,

G:−(V,E)→G[α,β] for any given state S. (eqn.1.)

That is to say the sub-ontology G is replaceable by the expression (V,E) and is mapped by the sub-ontology function G. In our modeling approach, we use a Directed Acyclic Graph that is a data structure of an ontology that is used to represent “state” graphically, and mapped or operated by an abstract function in our case represented as G, a function. The function's state changes are read as the rate of change in G with respect to events in [ε]. Therefore (eqn. 1.) is the graphical ontology representation with data properties identified in (V, E) driven by changes (remapping) in function G which is influenced by the dependent functions [α,β] respectively in Condition (1.).

Where:

V=Vertices (nodes) in G. V are the entities described semantically in Φ.

E—Edges between neighboring V. E⊂V×V where E is the set of all attributes that describe the relationship between vertex v₁ to neighboring vertices in Φ.

To capture state changes of attributes that semantically describe any entity in Φ, two functions are identified by α and β respectively:

α=Function αt: V→A_{α}, operates on current state of semantic attributes describing V.
β=Function β: →A_{β}, operates on current state of semantic attributes describing ε.

Where:

A_{α} Set of all attributes that semantically describe uniquely all entities in G and are operated on by α or known events ε. Thus Aₐ=[α₁ . . . , αₙ]

A_{β} Set of all attributes that semantically describe uniquely the relational interpretations between all entities, (i.e., the relational attributes and values of an entity to its neighboring entities), in G and are operated on by β or known events ε. Thus A_{β1}=[α₁, . . . , αₘ].

Therefore in any domain ontology, Φ, which semantically represents real world communities of interest that by nature are in a continuous change in state or entropy, (we use the definition of entropy, as in context of data and information theory, where measure of loss of information in the lifecycle of information creation, fusion and transmission, etc.), that classifies our system as having spontaneous changes in state. Our model represents functions that drive changes in state as the α and β functions.

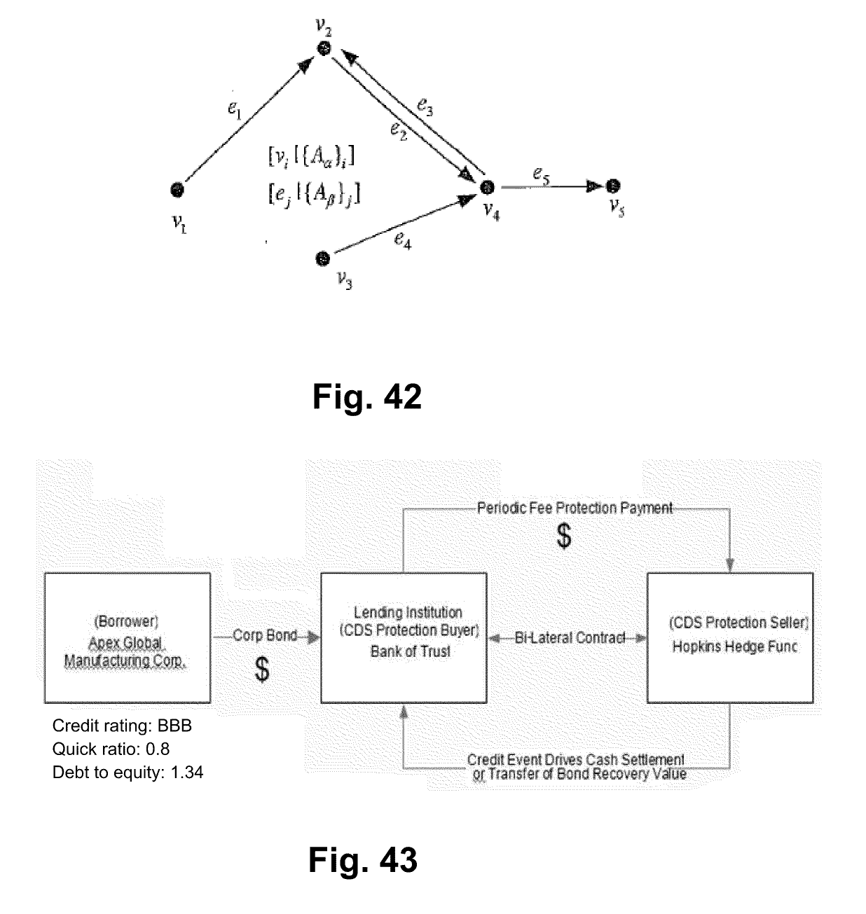

These functionally represent those natural predictable and unpredictable changes made by entities and their environment, (classified as events, processes, objects, persons and states of affairs), to the attributes that describe “meaning” to entities and to the strength of interpretive relations to neighboring entities. In this example, the inventive model operates under assumption that a state change in the attributes that describe data does not necessarily mean that the data itself has changed, but it can. As can be seen in FIG. 42, the model represented in (eqn. 1.) is shown as a directed acyclic diagram. This is an effective means of describing an entity as a member of a subset G shown as a spatial distribution of vertices and directional edges representing interpretive relationships described as relational attributes to and from all vertices. An entity can exist in the ontology an have no relations with other entities, but this is not represented since it is not of interest in our business context. The arrows defined as edges represent an interpretive relation between vertices. Using arrows rather than lines implies they have direction. Therefore an arrow in one direction represents a relation defined by vertex (1) to vertex (2). It is important to understand that the graph does not represent “flow” but only representation either of a vertex or a relationship to others vertices as its membership in the ontology. Our representation is “acyclic” because the relations defined do not cycle back to vertex (1) from all other vertices. However they could be pointing back depending on the complexity of the business domain you are describing.

FIG. 42, Directed acyclic graph representation of G plotted in b mapped as attributes describing each vertex, [V] ε V and edge, [e] ε E semantic meaning. The graph shows the strength and direction of relations between neighboring vertices at a current known state s.

Another example of the invention: Continuous Compliance Assessment Utility function

In another example, the invention provides a means of tracking and controlling a trackable single event on G. For this example, such mechanism is defined as Continuous Compliance Assessment, a utility function.

In this example, a Condition (2.) for the continuation of our model development is defined as,

$$Condition ( 2. ) \text{:} \frac{\partial G}{\partial ɛ} = c ⇒ s = f ( α , β , ɛ ) ,$$

where c is some arbitrary constant and [ε]=[ε₁], is a single event and occurs repeatedly over time T and is governed by a data process policy compliance mechanism. The Continuous Compliance Assessment Utility function is used to map onto the directed acyclic graph topology as:

G:=(V,E)→G[α,β,Γ(ε)] (eqn.2.)

This function governs known events as in the definition of ε as ε operates in G over some time t.

The assumption is that agents desire to produce, consume or transact information with governance according to policy. We propose a mechanism that provides data process policy compliance and transparency into the state changes that describe the meaning of data.

The new term in (eqn. 2) as compared to (eqn. 1.) acts as a policy compliance function and tracking mechanism driven by policies that operate on events and govern their outcomes, i.e., changes to state, affected by ε, as represented by the changes of attributes in G. The function is triggered by some occurrence of ε. The function operates on G and can affect the outcome of future events and simultaneously record the effects of events, processes, objects, persons, and states of affairs like data and information.

We further define this Continuous Compliance Assessment Utility function and expand (eqn. 2.) as,

Γ[P(A_{α}, A_{β}, Π, Z_{π}),D(R_{A}, Q_{A})] (eqn.3.)

The functional elements of eqn. 1 are described as utility sub-functions and are defined respectively as:

### Data Process Policy Function

P(A_{α}, A_{β},Π,Z_{π}) (eqn. 4.)

Π−Policy rule sets that contain rules or assertions
π=is a policy rule element where:
π₁+, . . . , +πₙ₋₁εΠ
π is a single logical Boolean assertion that tests conditions by evaluating attributes, past outcomes of events and rules used to determining whether an event can conditionally occur or not, where outcomes of

ε→Π

Z_{π} is the set of all obligations that operates in G. Obligations: Set Z_{π} is a collection of event like processes that are driven by policy rules in Π.

For example, an obligation can be characterized as an alert sent to the data owner about another data process policy driven event that is about to execute using “their” data with the objective of creating a new derivative informational product. The owner may have an interest in capturing and validating a royalty fee for the use of their intellectual property driven by policy, or the owner may be concerned with the quality inference based on the fusion of data that will exist relative to their data after the event.

Data Provenance Function

D(R_{A},Q_{A}) (eqn.5.)

This utility function operates as a recording and querying function and tracks the provenance of any type of data where:

R_{A}=Data provenance recording function captures and stores state changes for all sets f attributes [|A_{α},A_{β}] for an event εi.e., Δ₁₂, Δ_{23 . . .} , Δ_{i-1, i} where Δ_{i, j}, is the difference from version i to version j.
Q_{A}=Data provenance querying function queries state changes for all sets of attributes [A_{α},A_{β}] for an event ε i.e., Δ₁₂, Δ_{23 . . .} , Δ_{i-l, i} where Δ_{i, j}, is the difference from version i to version j. For example version A_{α,1} together with sequence of deltas Δ₁₂, Δ_{23 . . .} , Δ_{i-l, i} is sufficient to reconstruct version i and versions 1 through i-1.

Data provenance is the historical recording and querying of information lifecycle data with a life cycle of events. We conceptualize data provenance as consisting of five interconnected elements including when, where, who, how and why. The disclosure of concepts of data provenance in Ram, Sudha and Lui, June, 2007, Understanding the Semantics of Provenance to Support Active Conceptual Modeling. Eller School of Management, University of Arizona, is incorporated by reference herein in its entirety.

In another example, the inventive ontology model provides the description of what events in the Data Process Policy evaluation, simply tracking and recording the what events that occurred is not sufficient to provide meaningful reconstruction of history. Without the what described in the ontology, the other five elements are irrelevant. Therefore the five elements listed meet the requirements of data provenance in our model.

Capturing data provenance in our model facilitates knowledge acquisition by active observation and learning. With this capability agents can reason about the dynamic aspects of their world, for example a capital liquidities market. This knowledge and the functional means to act on it facilitate prediction and prevention as we will see later in further model development. The Data Provenance function uniquely provides several utilities to agents seeking to continuously measure and audit data quality, conduct continuous risk assessments on data process policy driven events, and create or modify derivative informational products. These utilities are as described as:

Data quality: data provenance provides data lineage based on the sources of data and transformations.

Audit trail: Trace resource usage and detect errors in data generation.

Replication recipes: Detailed provenance information can allow repeatability of data derivation.

Attribution: Pedigree can establish intellectual property rights or IP that enables copyright and ownership of data and citation and can expose liability in case of erroneous data

Informational: Data discovery and can provide ability to browse data to provide a context to interpret data.

The full disclosure of utilities of data provenance function in Sinunlian, L. Yogesh, Hale Beth and Gannon Dennis, A Survey of Data Provenance in e-Science, SIGMOD Record, Vol. 34. No. 3, September 2005 is incorporated by reference herein.

In another example, the inventive model may reflect real would behavior by having, in Condition (3.), the rate of change of state for the sub-ontology G with respect to change in event to be equivalent to the entropy functions and the rate of change of the Continuous Compliance Assessment Utility function with respect to change in event ε. This implies that the state of G is a function of the entropy functions α and β respectively and the trackable known events driven by agents defined in the ontology. It is assumed that not all agents are aware of when the occurrence of a particular event driven by some arbitrary agent is to take place in the ontology. Therefore our model is influenced by all events and is represented in condition declaration as.

$$Condition ( 3. ) \text{:} \frac{\partial G}{\partial ɛ} = G [ α , β , \frac{\partial }{\partial ɛ} Γ [ P ( {A}_{α} , {A}_{β} , Π , {Z}_{π} ) , D ( {R}_{A} {Q}_{A} ) ] ⇒ s = f ( α , β , [ ɛ ] ) ,$$

where [ε]=[ε₁, . . . , εₙ] is a series of unique events respectively occurring over time period [T] and are governed by a data process policy compliance mechanism. This mechanism again is the Continuous Compliance Assessment Utility function.

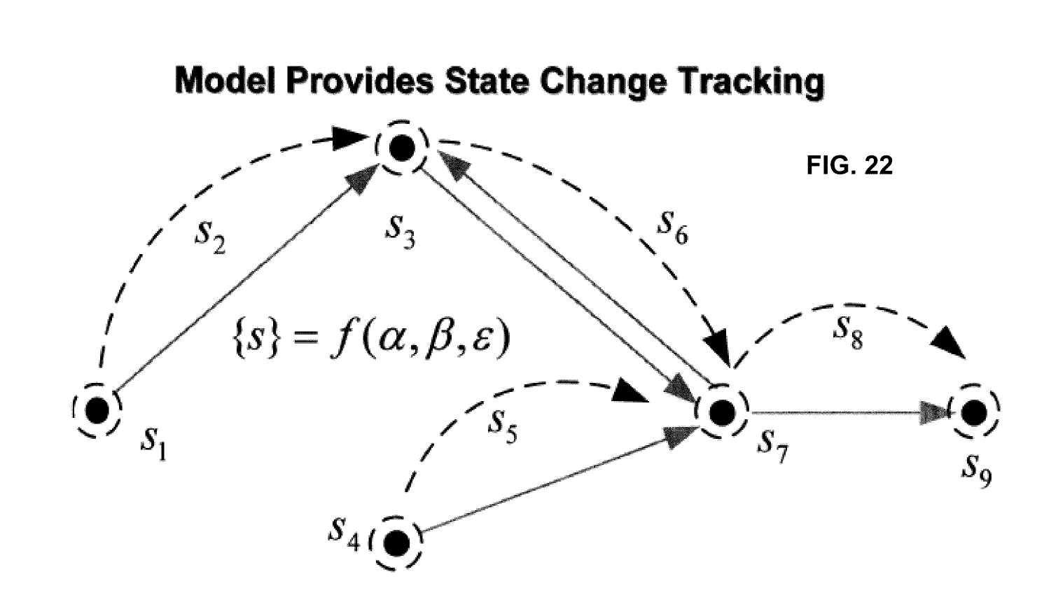

In another example, the inventive model predicts that events occurring in a market as modeled are defined as series of synchronous and asynchronous events occurring for some time period [T]. In another example, the inventive model assumes that a path in G can be layered on top of the ontological topology governed by the Data Process Policy Function Γ. For any event to proceed there was policy decisioning that governs the event, i.e., a process on a data transaction between two entities. The path is represented by the dotted state representations across G as shown in FIG. 22. The “overlay” of state changes (represented as dotted arcs and circles) onto G show that one could track “flow” through the map if one tracks the state changes (data provenance) for every event that operates on the ontology over time [T].

In FIG. 22, states are plotted over G based upon events ε that change states S₁ . . . Sₙ. Events are governed by data process policies. The circles and arcs represent policy driven event state change of the attributes belonging to the vertices and edges i.e., (V, E) in G.

In another example, the inventive model assumes relative to Condition (3.) that data process policies can be introduced at any time into the model and that those agents of policy rarely update their policies due to reasons of economic costs, transparency, cultural conflicts or even fear of exposure associated with not having the capability to provide policy measurement and feedback. The interesting dilemma that impacts this condition is that, over time, the system (in our case a market) changes state independent of the influence of known or planned events due to its existence in nature which represents continuous change. These changes are driven by outside events that are generally unknown and unpredictable. Further, the independent relationships between the system's vertices and nature can introduce changes that can be amplified by interdependent relationships between vertices within, the system. What this implies is that the effectiveness and efficiency of agent polices will erode over time. What is needed is the ability to detect change and measure the impact it has on policy effectiveness so that adjustments can be considered, modeled, and evaluated to keep the system on course to the desired objective.

Feedback and Learning

In another example, the inventive model provides a mechanism for measurement and feedback of policy and attribute. We assume all agents will frequently make adjustments to policies that govern certain event outcomes with the introduction of this mechanism. It is assumed that idiosyncratic risk exists in the market such that any one agent's information does not correlate across all agents in the market. By modeling entropy functions α, β into our ontology model in Condition (1.), we create unpredictable, and in some cases, probabilistic noise that influences event outcomes of “known” policy driven events. These effects may cause small perturbations to domain attribute ontology representations. Furthermore, large scale Knightian uncertainty (i.e., immeasurable risk) type events could be introduced into our model through α, β. One could test events of this nature by creating significant imbalances to a capital markets liquidity ontology model, an unknown event. The outcome is predicted to reflect market-wide capital immobility, agent's disengagement from risk, and liquidity hoarding. One can test and observe the quality of this prediction by auditing the evolution of agent's policies as Knightian conditions evolve. The full disclosure of Caballero, J. Ricardo and Arvind Krishnamurthy, Collective Risk Management in a Flight to Quality, journal of Finance, August, 2007, in incorporated by reference herein.

In another example, the inventive GRACE-CRAFT consultative model may enable both human and corporate resources to discover these effects and provide agents the ability to predict and manage Knightian risk, thus converting it from extraordinary to ordinary risk. In another example, let's look: Assume agents want to continuously measure outcomes of events and provide feedback as policy and attribute changes in (eqn. 1) by using some new function K evaluated at (ε-1), since we can't measure an event ε outcome before it occurs. We add K function to our model as seen in (eqn. 6). We assume K has sub-functions α,β, Γ.

$$G := ( V , E ) \to G [ α , β , \frac{\partial }{\partial ɛ} Γ [ P ( {A}_{α} , {A}_{β} , Π , {Z}_{π} ) , D ( {R}_{A} {Q}_{A} ) ] ] \pm K ( α , β , \frac{\partial }{\partial ɛ} Γ ) \qquad ( eqn . 6. )$$

Expanding the right side of the equation (eqn. 6.) for K, where Rₚ=0 in Γ for the measurement and feedback utility functions and integrating over all events F, in time yields,

$${\int }_{ɛ} [ G [ α , β , \frac{\partial }{\partial ɛ} Γ [ P ( {A}_{α} , {A}_{β} , Π , {Z}_{π} ) , D ( {R}_{A} {Q}_{A} ) ] ] ] d ɛ \pm {\int }_{ɛ - 1} [ K [ α , β , \frac{\partial }{\partial ɛ} Γ [ P ( {A}_{α} , {A}_{β} , Π , {Z}_{π} ) , D ( {Q}_{A} ) ] ] ] d ɛ \qquad ( eqn . 7. )$$

In another example, the inventive model may take in to consideration the Continuous Compliance Assessment Objective Function

The Continuous Compliance Assessment Objective function, it is assumed to be continuous in G, provides measurable feedback to agents and enables them to make adjustments to policies and attributes to meet their respective objectives in the market. In another example, the Continuous Compliance Assessment Objective function provides feedback that enables agents steadily, though asymptotically, to converge on their objectives while simultaneously recognizing that these objectives, like real life, evolve as the agent's experiences, perceptions and relationships with other agents, data, and processes evolve. Agents will apply objective measurement functions that they deem most effective in their specific environment.

In another example, the objective function's purpose is to provide utility to all agents. Agents' policies will reflect their results and experience they gain from this function as attribute descriptions. Policy evolves as making risk management decisions are made that influence future outcomes based on past risk assessments. Agent adjustments to policies aggregate to impact and influence market behaviors going forward.

In another example, the inventive model provides a mechanism for testing the effectiveness of polices governing data and information quality and the derivative enterprises and economies that depend on that quality and transparency.

The Continuous Compliance Assessment Objective function can be expressed as:

$$K ( ɛ - 1 ) = MinMax [ {\int }_{k} [ K ( α , β , \frac{\partial }{\partial ɛ} Γ ) d k ] ] \qquad ( eqn . 8. )$$

Note: For every ε, we assume agents sample K(ε-1) or last known event in attempt to make adjustments or not to policies based upon their continuous risk management decisioning in K(ε-1). This therefore provides feedback into the G at the evaluation at ε.

Agents' min-max preferences provide descriptions of their decision policies. The objective function in eqn. 8 provides the utility to alter future outcomes of known events and adapt to changing market states. Overtime agents learn to penalize or promote behaviors that detract or contribute to achieving specified objectives. This reduces uncertainty and risk aversion in volatile markets.

In Another Example of Application of the GRACE-CRAFT Model

In this example, the GRACE-CRAFT model integrated over all events ε for some time set [T] is fully described as:

$${G}_{ɛ} := ( {V}_{ɛ} , {E}_{ɛ} ) \to {\int }_{ɛ} [ G [ α , β , \frac{\partial }{\partial ɛ} Γ [ P ( {A}_{α} , {A}_{β} , Π , {Z}_{π} ) , D ( {R}_{A} {Q}_{A} ) ] ] ] d ɛ \pm {\int }_{ɛ - 1} [ MinMax [ {\int }_{k} [ K ( α , β , \frac{\partial }{\partial ɛ} Γ ) ] d k ] ] d ɛ \qquad ( eqn . 9. )$$

This function maximizes the utility of information based data quality measurement. As such it measurably increases risk assessment effectiveness which measurably increases the efficiency of risk management investment prioritization. As a result, the whole ontology (or, in the business context of this paper, “the market”) enjoys measurable gains in operational and capital efficiencies as a direct and predictable function of measurable data and information transparency and quality. It enables noncompliance liability exposure to be rationally and verifiably measured and managed by providing policy makers, executives, and managers with simple tools and a consistent and verifiable mechanism for measuring and managing non-conformance liability exposure. As a result, they are freed to focus on the quality of the objectives for which they are responsible and accountable.

### Another Example of Application of GRACE-CRAFT Model: Continuous Compliance Assessment Objective Function:

In this example, the model accommodates whatever type of objective function best suits an agent's policy requirements. In some cases this might be an Nash Equilibrium or other game theory derived objective functions. In many business and financial ontology contexts linearized or parametric Minimax and other statistical decision theory functions may be more appropriate.

### Another Example of Application of GRACE-CRAFT Model: A Data Quality Measure—An Approach

For example a data quality measure function would measure a particular metric of interest such as “quality” (actual model used trust as a metric). The full disclosure of the data quality measure function as disclosed in Gotheck, Parsia and Hendler, 2002, Trust Networks on the Semantic Web, University of Maryland. URL:www.mindswan.orgivapers/CIA03.pdf, is fully incorporated by reference herein. The product of the function evaluated continuously in G′ would be evaluated and used to make adjustments either by automated machine process or human adjustments using [α,β,Γ]. It is assumed that a set of values for quality have been predefined and standardized by the market, i.e., the set of all standard values that represent quality=[q₁, . . . , qₚ], where q ε e. Therefore, based on outcome at an instance in the continuum of events attributes, policies and obligations are adjusted and reintroduced into P(A_{α}A_{β}, Π, Z_{π}) in an attempt to ensure maximum trust between known entities (vertices) represented by the recursion formula:

$$q ( is ) = \frac{{\sum }_{j = 0}^{n} \{ \begin{matrix}( q ( js ) * q ( ij ) ) & if q ( ij ) \geq q ( js ) \\ ( {q}_{ij}^{2} ) & if q ( ij ) < q ( js )\end{matrix} \}}{{\sum }_{j = 0}^{n} q ( ij )} \qquad ( eqn . 10. )$$

The assigned quality q, an attribute metric of interest that is tracked continuous in G, is defined as the perceived quality from vertex i to vertex s and is calculated where i has n neighbors with paths to S. This algorithm ensures that the risk down the information value chain is more\less than the quality at any intermediate vertex.

### Another Example of Application of GRACE-CRAFT Model: Policy Effectiveness Measurement—An Approach

This algorithm and approach assists agents in determining statistically the effectiveness of their policies on enforcement and compliance while meeting certain objectives. Measures are consistently compared to last known policy outcomes. While a benchmark is assumed to be measured at the first introduction of a policy set, it is not a necessity and measure can begin at any time during the lifecycle of the agent belonging to the member business concept ontology. However, it is important to know where one has begun to influence behaviors with policy. As such this mechanism provides a consistent, repeatable, and independently verifiable means of quantifiably assessing the degree of compliance with policies governing simple and complex applications of policies to specific processes, events and transactions, objects, and persons.

### Define:

Π=Policy rule set
π=Policy rule
Assume: π₁+, . . . , +πₙ₋₁εΠ∴{π(1)+, . . . , +π(n-1)}∪Θ [symbol] (π(n)εΠ)=Proof, Θ
Thus to evaluate the rules (assertion) in Π and quantify value θ for Proof Θ we can use the following series expression:

$${\sum }_{i = 0}^{n} π ( i ) * r ( i ) = 0.$$

where he value of r(i)=risk weighting factorε Φ Ontology set. Let r=(1- [symbol] ), where [symbol] is there data owners “perceived risk” of sharing as defined in b Ontology set. For example an owner may have 60% perceived risk to share with entity X.
Now assume the following Proof Φ types:

### Orthoganal Proof, Φ:

1.)π₁+, . . . , +πₙ₋₁⊥Π [symbol] all assertions are independently formed
2.) All {π₁+, . . . , +πₙ₋₁}must be evaluated as logical true, value=1

### Relative Proof, Φ′:

1.) {π₁+, . . . , +πₘ}⊥ in Π
2.) {π₁+, . . . , +πₘ}not all true but {r₁+, . . . , +rₘ}≦acceptable limits.
Let the Orthoganal Proof Φ be the benchmark from which we measure the policy compliance effectiveness for Relative Proofs Φ′. Φ′ is samples over a discrete time t period from which policy set evaluations generate rulings ach measured as θ′ for user data access request in the RAFT model.
Therefore policy compliance effectiveness measure is the Standard Deviation in Θ′ or the degree to which θ′ of Relative Proof Θ′ has variance from the Orthoganal Proof Θ.
The Standard deviation is:

$$\begin{matrix}σ ( policy ) = \sqrt{\frac{1}{N - 1} {\sum }_{i = 1}^{N} * {( {θ}^{′} - θ )}^{2}} \\ = \sqrt{\frac{1}{N - 1} {\sum }_{i = 1}^{N} {( {\sum }_{j = 1}^{m} ( {π ( j )}^{′} * {r ( j )}^{′} ) - {\sum }_{i = 1}^{k} ( π ( i ) * r ( i ) ) )}^{2}} ,\end{matrix}$$

for N samples and where r is the risk weight factor in ontology set Φ.
Therefore σ(policy) is the degree in variance from the Orthoganal Proof Θ. This variance is the direct measure of effectiveness in policy compliance in Θ′. The N Samplings of Θ′ are taken from the GRACE-CRAFT Immutable Audit Log over a known time period t.

### Another Example of Application of GRACE-CRAFT Model: Bringing Transparency to the Credit Default Swap Market

For practical application we will build certain concepts and components of a simple GRACE-CRAFT model using a Credit Default Swap mechanism as application context. The objective of this application is to provide consultative guidance on how one defines the business domain ontology, policies and attributes that govern an instance of the GRACE-CRAFT model.

Above, it is described the types of functions the GRACE-CRAFT model supports. These include the Event Forcing functions ε: The Entropy functions α and β: The Data Process Policy functions and their corresponding Obligation functions

$$\frac{{ΔΔ}_{α}}{Δ ɛ} , \frac{{ΔΔ}_{β}}{Δ ɛ} , Π , {Z}_{π} ,$$

The Data Provenance functions

$$\frac{Δ {R}_{A}}{Δ ɛ} , \frac{{ΔQ}_{A}}{Δ ɛ} .$$

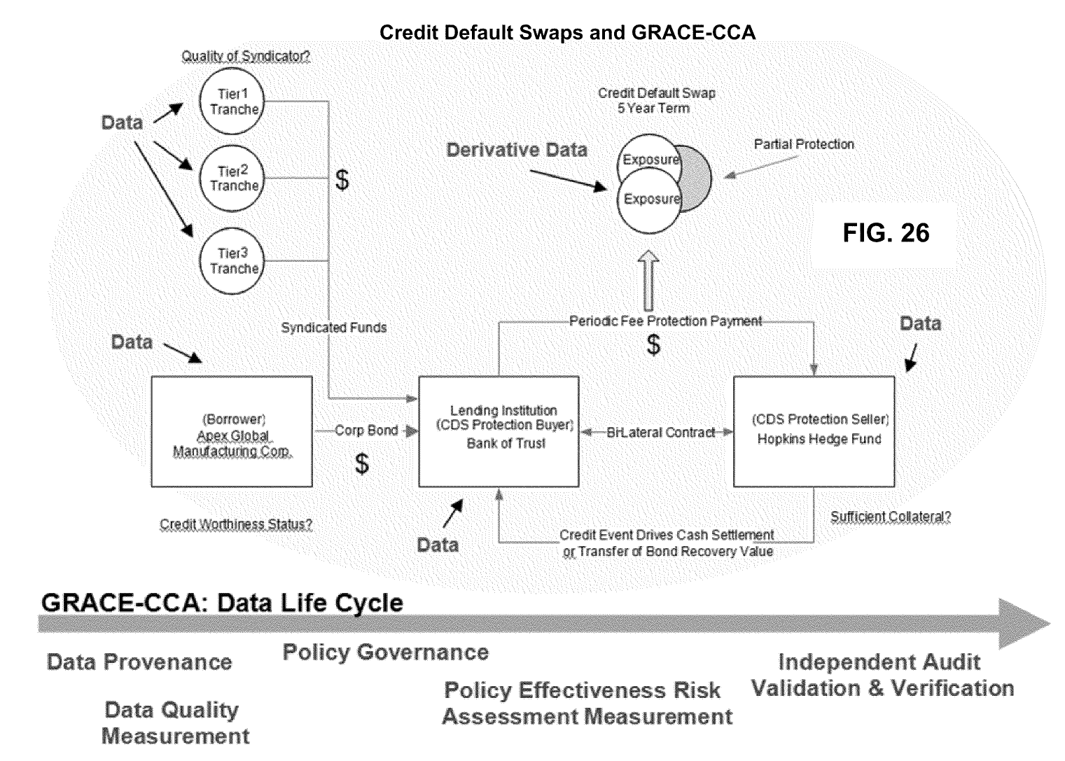

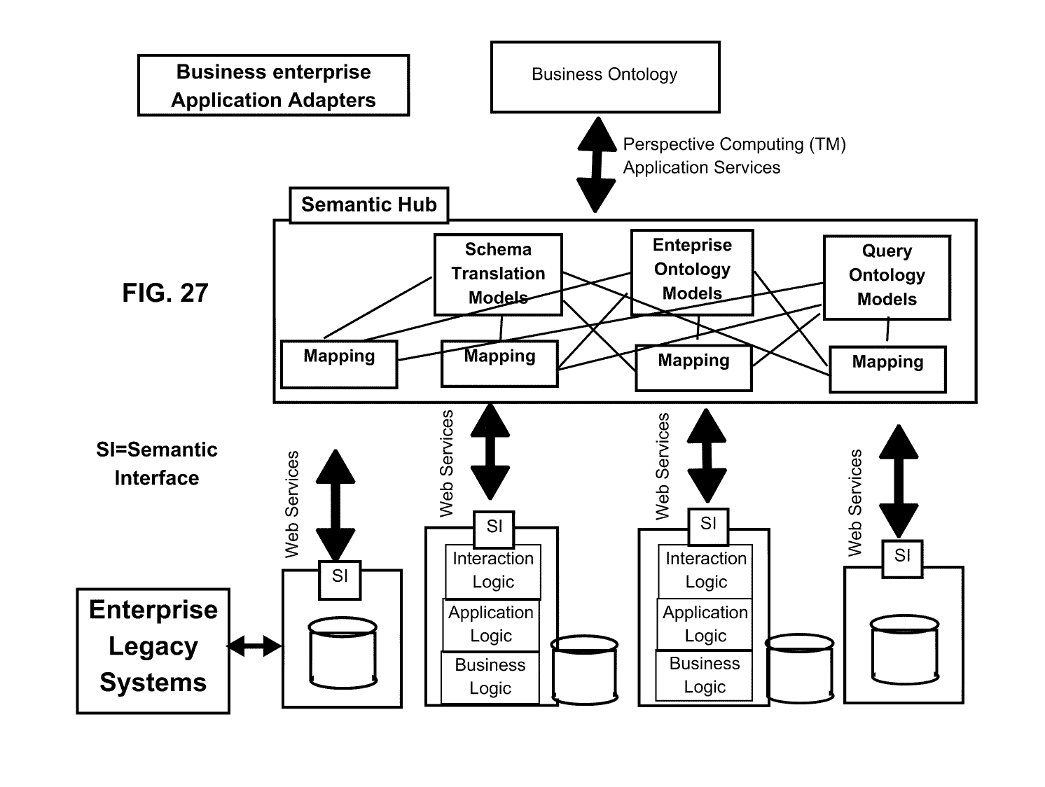

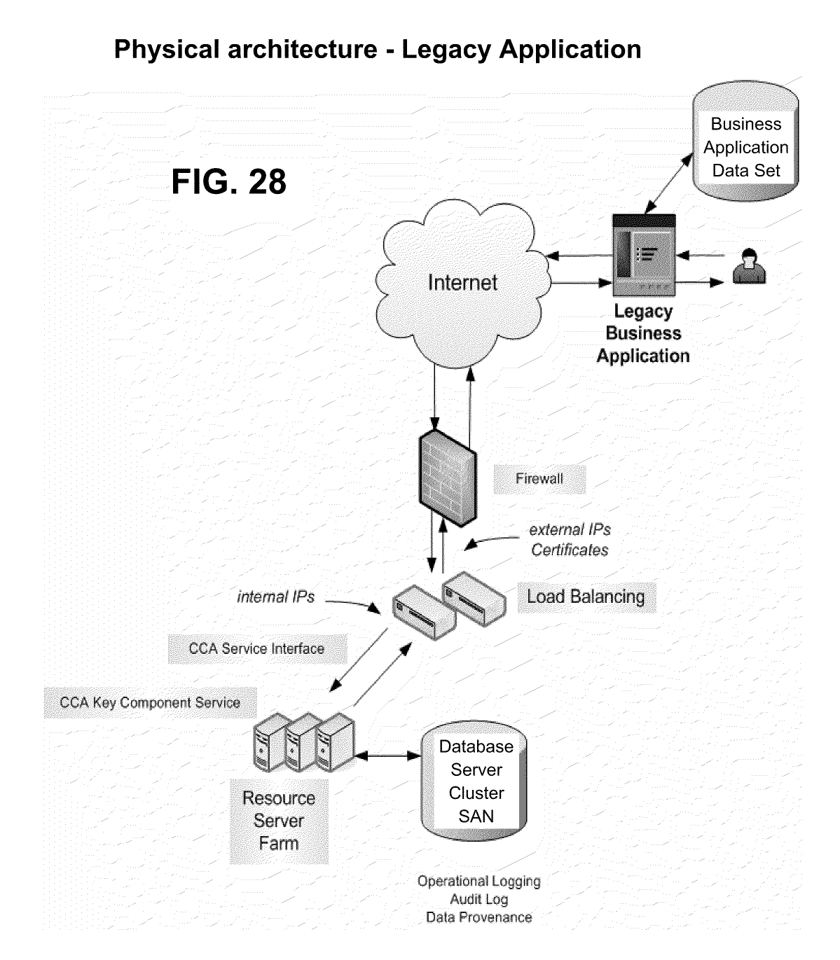

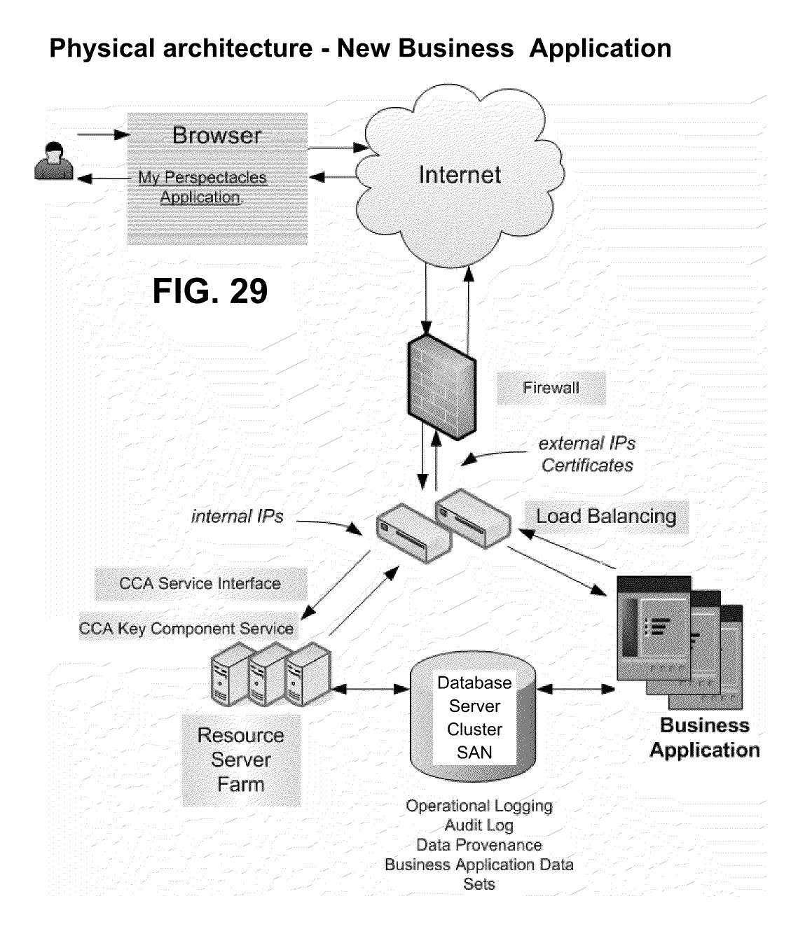

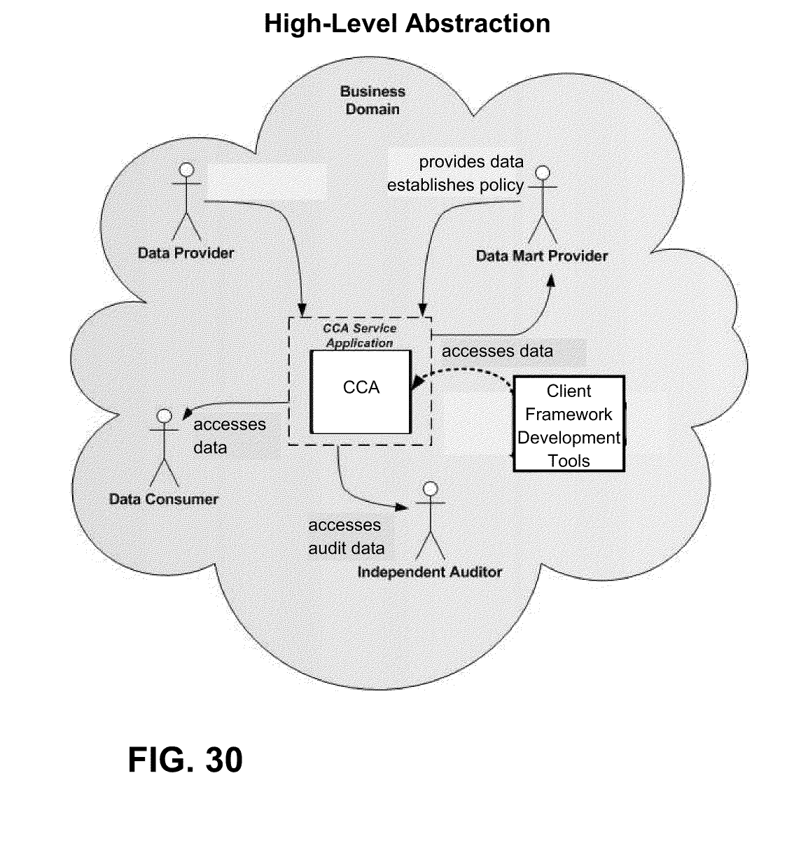

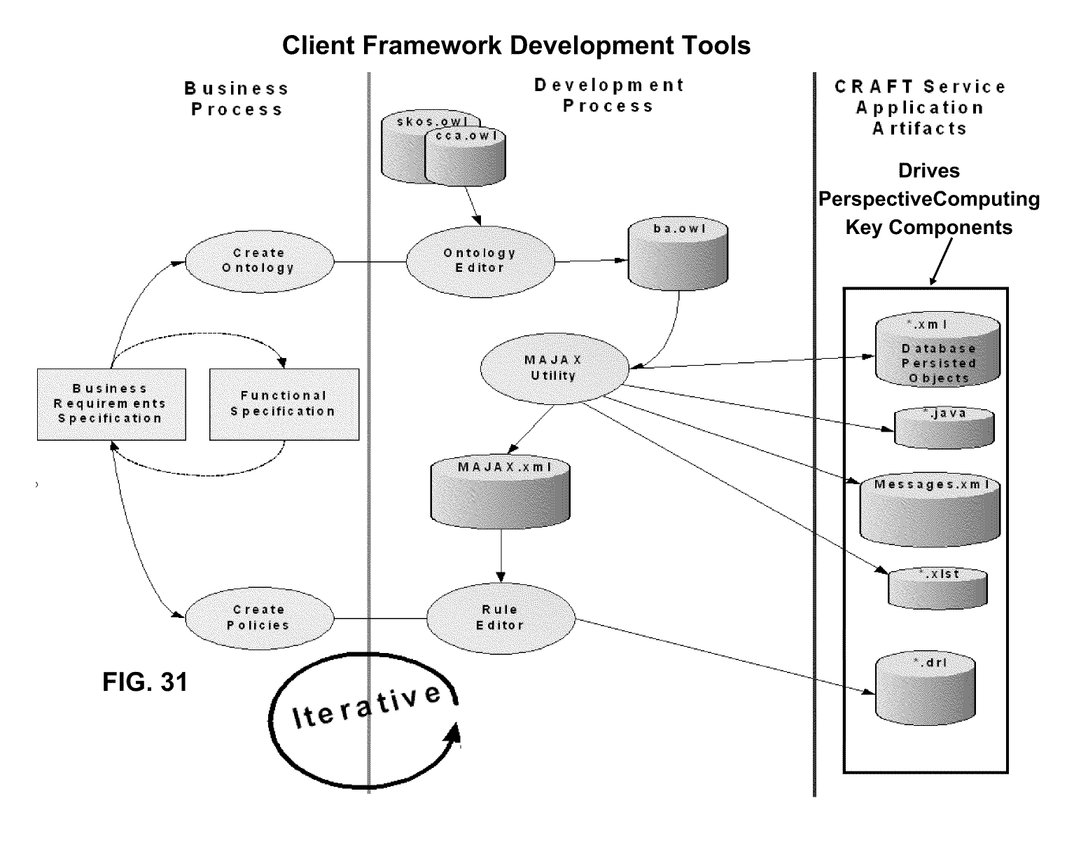

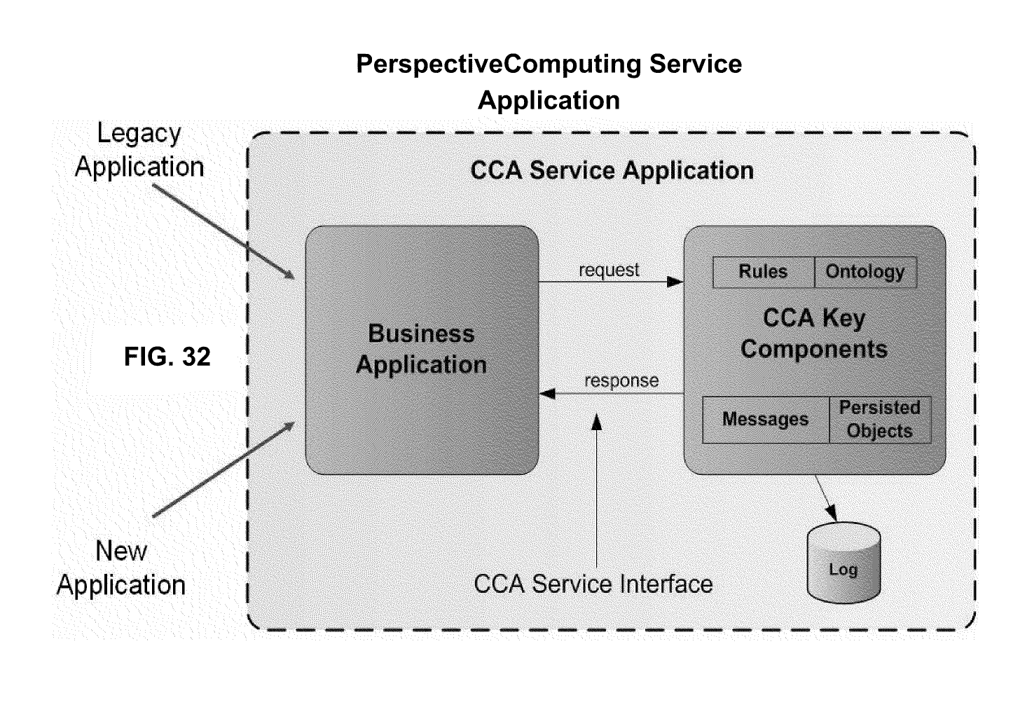

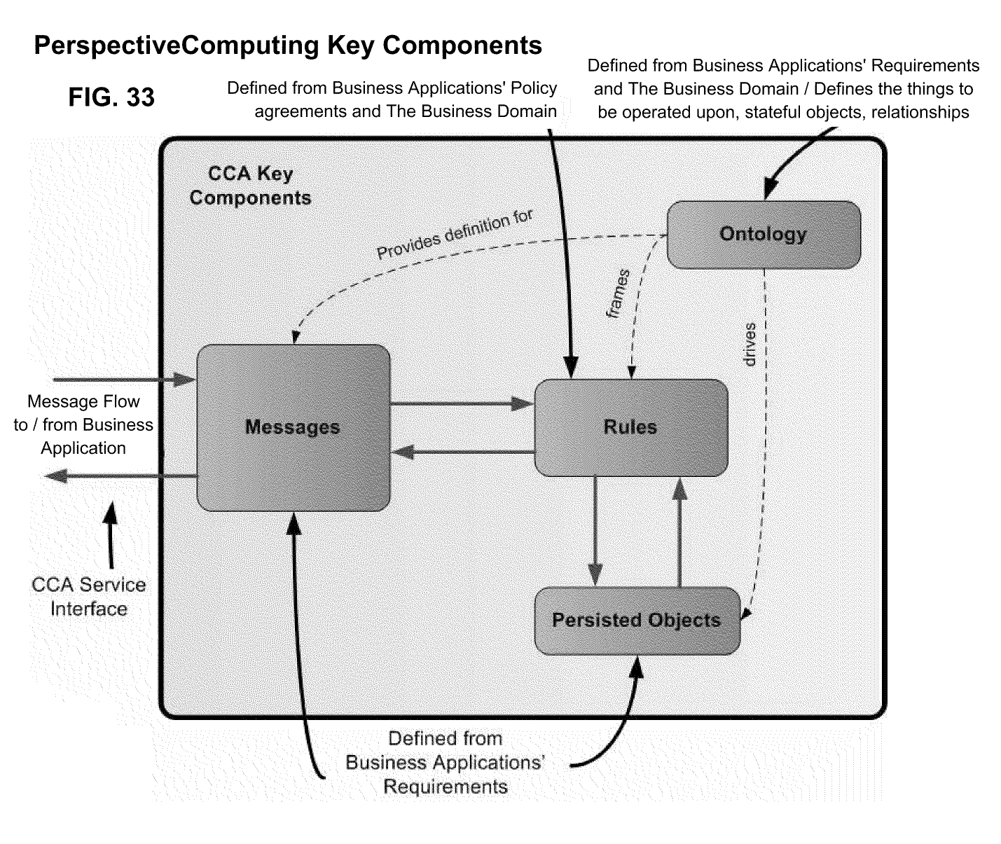

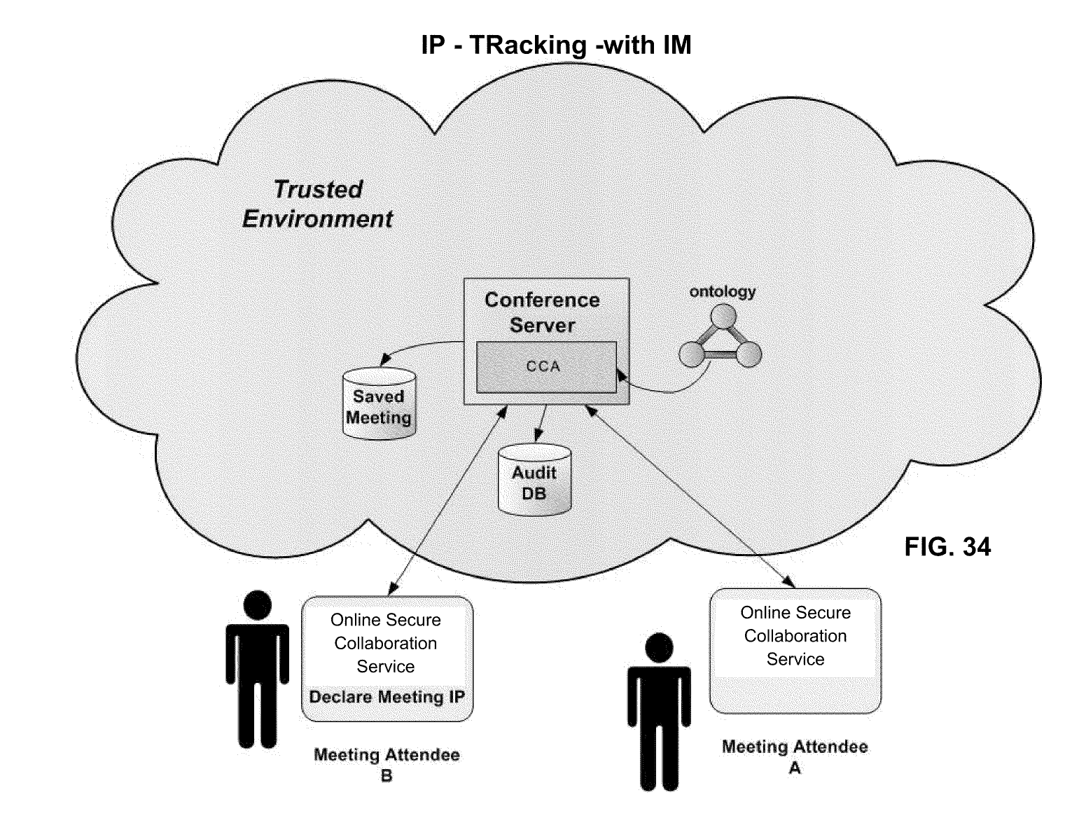

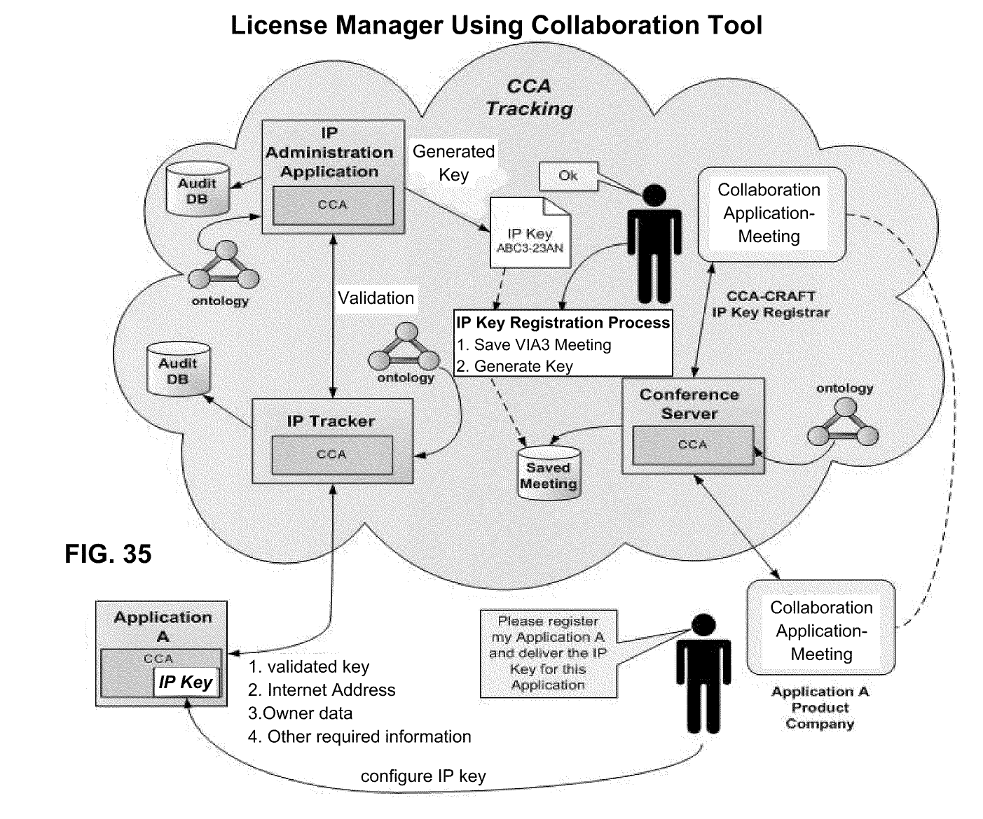

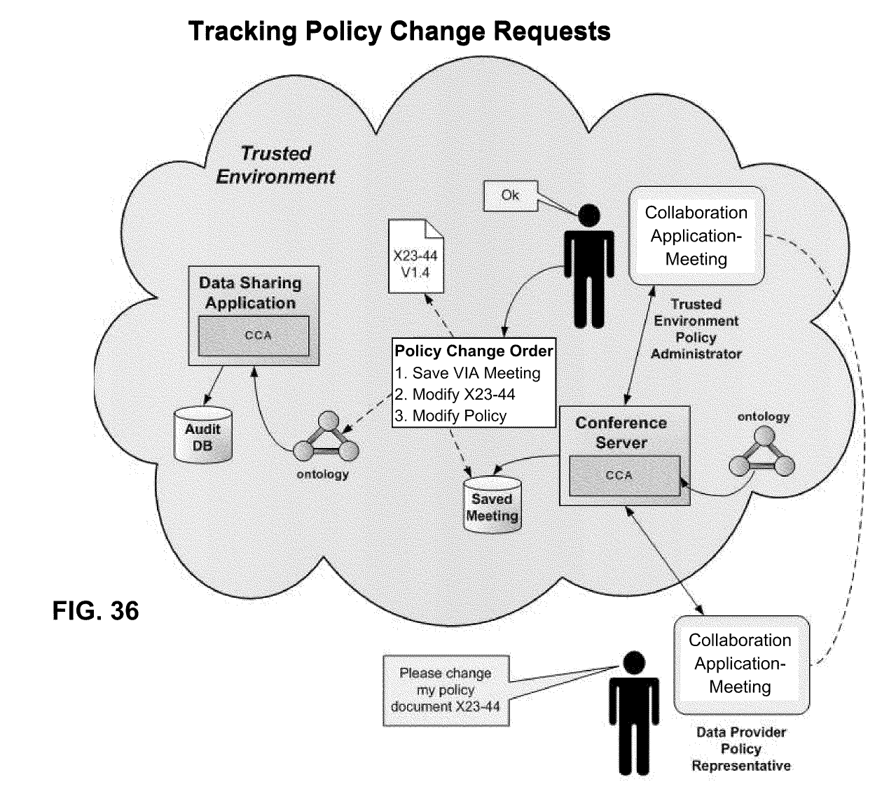

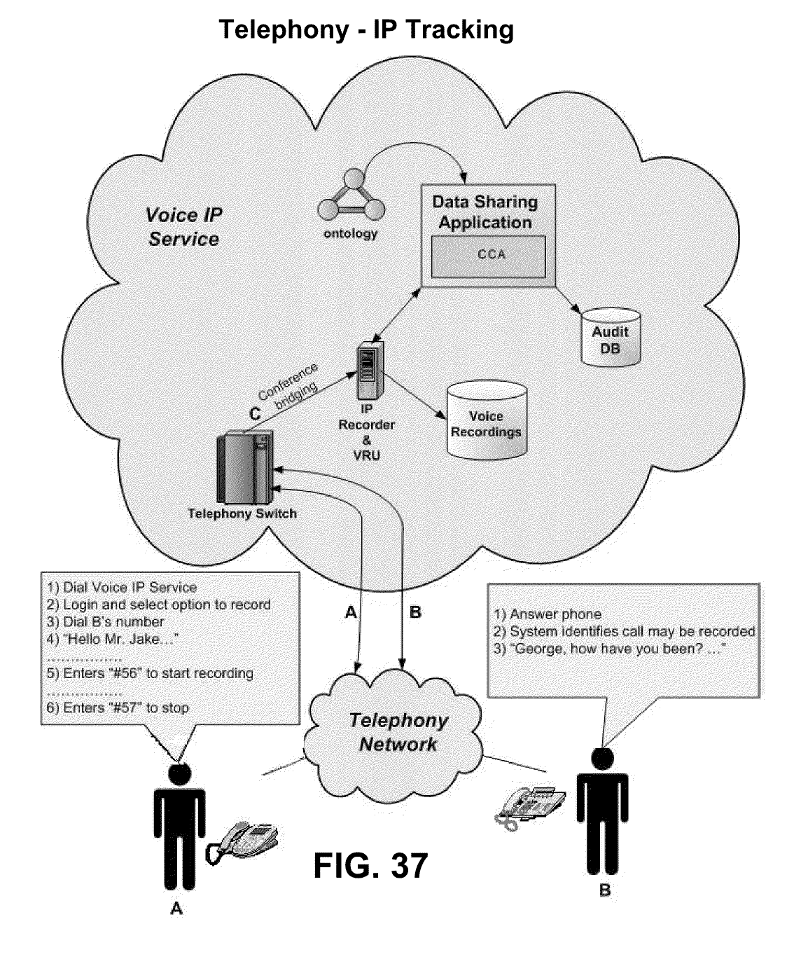

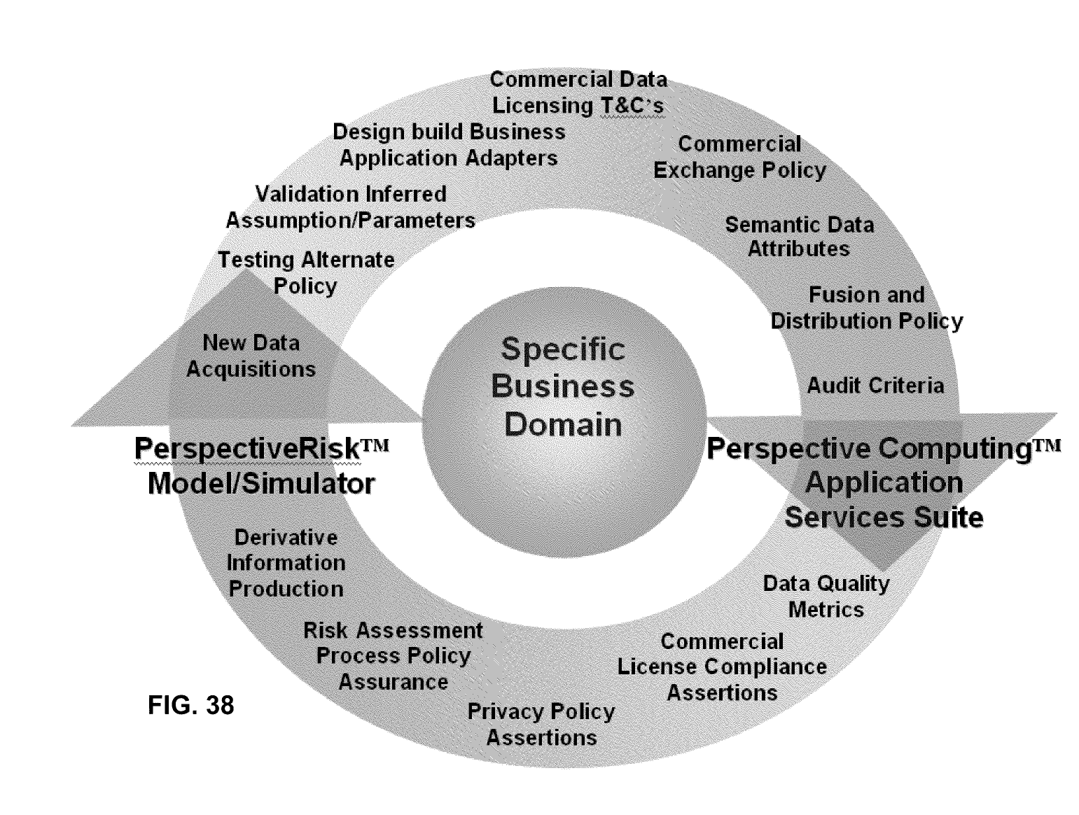

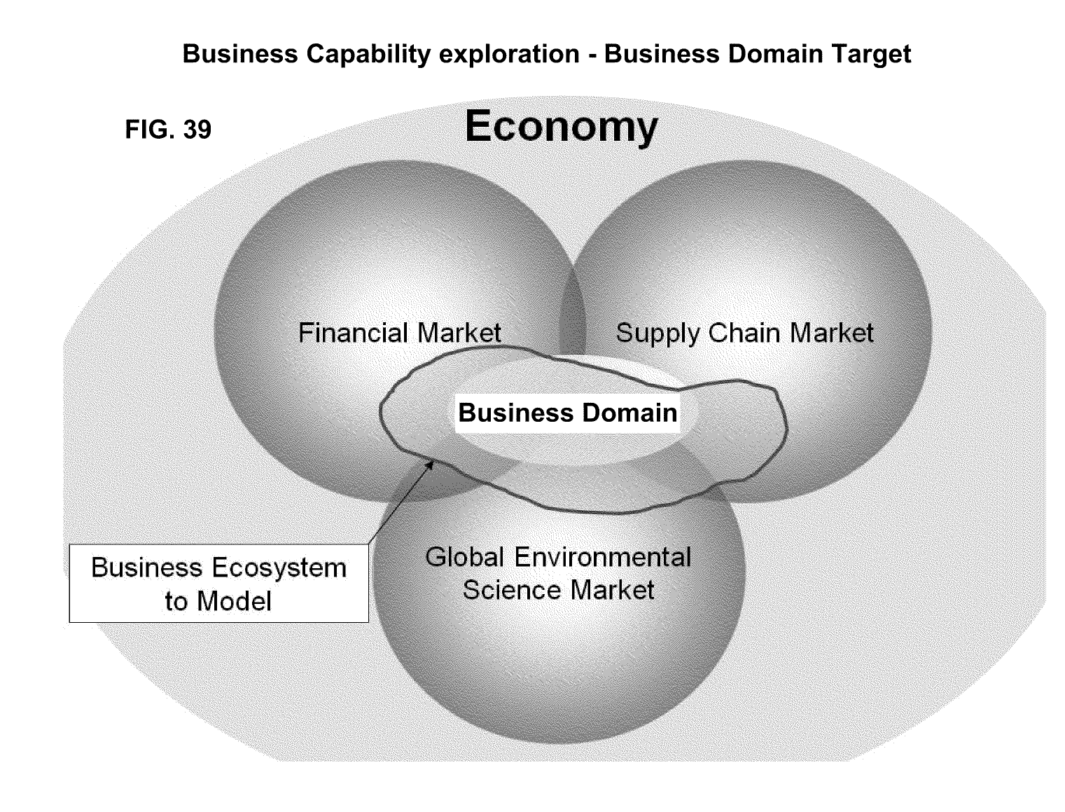

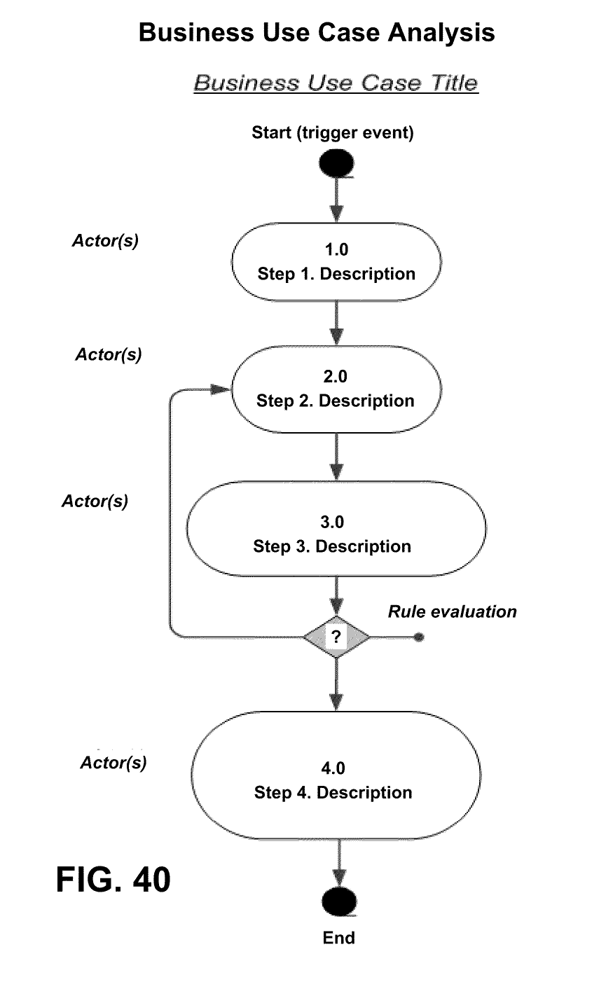

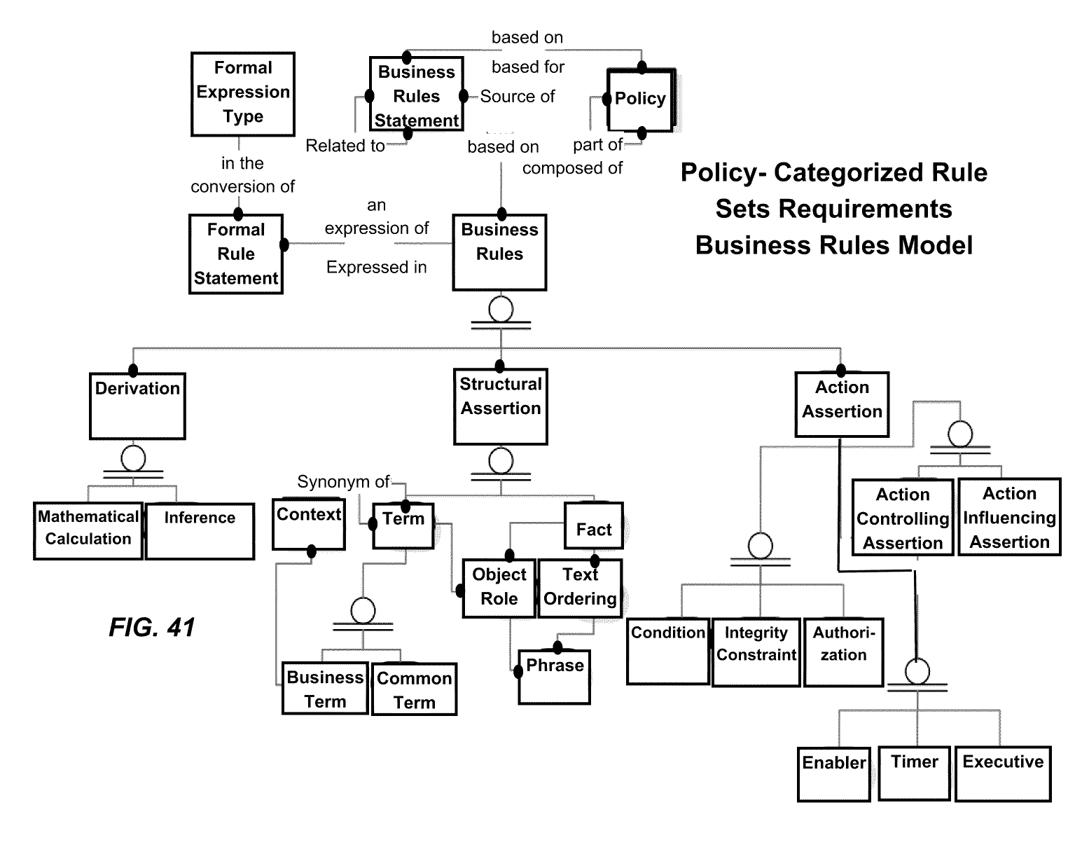

These functions can be designed empirically, statistically or probabilistically or be based upon existing real-world physical system models. Each selected function needs inputs for initial conditions. You'll often use ranges of values to support certain functions and to conduct experiments and simulate different situations and circumstances. In the Credit Default Swap evaluation model we'll construct by way of example, we will demonstrate one approach to building the necessary components using use cases that can be designed from a simplified diagram of a typical CDS landscape (See FIG. 26.). This is an effective approach for discovery and exploration of the entities, relationships between entities, attributes, and policies governing business process, data, obligations, etc. These entities, relationships, attributes and polices are the basic building blocks of the model's ontology.

Setting the Table

A typical Credit Default Swap (CDS) landscape is shown in FIG. 26. This diagram illustrates business entities and their respective relationships in a simplified CDS life cycle. Many use cases can be designed from this simplified diagram. The diagram represents the beginnings of a knowledge base a GRACE-CRAFT modeler will develop to support the ontological representation if his or her GRACE-CRAFT model. For purposes of this application we are simplifying the CDS market application representation for the sake of brevity.

In another example of application of the invention, Apex Global Manufacturing Corporation, as seen in FIG. 26, needs additional capital to expand into new markets. Bank of Trust, Apex's lending institution, examines Apex Global Manufacturing Corp's financials and analyzes other indicators of performance they think are important and concludes that Apex represents a “good” risk. Bank of Trust then arranges an underwriting syndication and sale of a 10 year corporate bond on behalf of Apex Global Manufacturim Corp. The proceeds from the sales of Apex's bonded debt obligation come from syndicated investors in Tier 1, Tier 2, and Tier 3 tranches of Apex's bond. Each of these syndicates of investors have unique agreements in place covering their individual exposure. Typically these include return on investment guarantees and percent payouts in case of default.

Bank of Trust decides to partially cover its calculated risk exposure to an Apex default event by entering into a bi-lateral contract with Hopkins Hedge Fund. They based the partial coverage decision on an analysis of the current market cost of full coverage and the impact that would have on their own ROI compliance requirements which are driven by the aggregate interest rate spreads on the Bank's corporate bond portfolio.

Bank of Trust's bi-lateral agreement with Hopkins encompasses the terms and conditions negotiated between the parties. Value analysis of the deal is based upon current information (data and knowledge) given by both parties and is used to define the characteristics of the CDS agreement. It is assumed that “this” information is of known quality (a data provenance attribute) from the originating data sources and processes used to build the financial risk assessment and probabilistic models that determined the associated risks and costs of the deal, e.g. the interest on the Net Present Value of cash flows to be paid by the Bank during the five year life of the CDS and the partial payout by the Hopkins Hedge Fund in case a default event on the Apex bond. It is important to keep in mind that once the bi-lateral agreement is in place, the Apex corporate bond and the CDS agreement with Hopkins Hedge Fund are linked assets; and can be independently traded in financial markets around the world.

In theory a CDS should trade with the corporate bond it is associated with. In practice this has not always been the case because CDS trades have typically been illiquid party-to-party deals. Another characteristic of typical CDS trades has been that they have not been valued at mark to market, but rather at an agreed Book value on a day relative to the trade. This can overstate the value significantly. Valuations for the CDS and the underlining instrument being hedged are based upon measures such as average risk exposures, probability distributions, projected cash flows, transaction costs, etc. associated with the asset linkage. These analyses are typically made from aggregate data sources and known processes used to build the structured deals that provide the basis for valuation. In a better world, when these assets trade to other parties the information layer, i.e., the provenance of the deal describing the structure, risk, and valuation would transfer as well. Unfortunately, in the real world of unregulated transaction volumes ballooning from $900 Billion in 2000 to over $45 Trillion in 2007 this risk quality provenance seldom transferred with the instruments. The result is not pretty; but it is instructive.

In another example, the GRACE-CRAFT modeler first identifies and documents the policies that describe and govern the quality of the data used to define risk of the instruments. These might include data source requirements, quality assertion requirements from data providers, third party risk assessment rating requirements, time stamp or other temporal attributes, etc_ The same is true of the polices governing the quality and integrity of the processes used to manipulate the data, support the subsequent valuation of the instruments, and support the financial transactions related to trading the instruments.

The GRACE-CRAFT modeler will use this awareness and understanding of the nature and constraints of the polices governing the data used to assess risk and establish the valuation of the instruments being examined to identify and track changes over time and model the affects of those changes on the effectiveness of the policies governing the valuation of the instruments themselves.

FIG. 26, illustrates the modeler's representation of the information layer inputs identified as data sources. It also shows how the data flows through a typical CDS landscape and the CDS itself as a derivative information product of that data.

The precision of the model will be governed by the modeler's attention to detail. The analyst must choose what data from what source or sources to target. This will generally, but not always be a function of understanding the deal buyers' and sellers' requirements, the mechanics and mechanisms of the deal. This understanding will inform the analysts as identification and understanding of the important (generally quality and risk defining) attributes of the data from each source, and the policies used to govern that data and the transactions and other obligations associated with the deal.

The inventive GRACE-CRAFT model can be used to analyze and experiment with alternative information risk assessment results that result from different policies governing source data quality and derivative products. As such the modeler can use his or her model test and evaluate how various data quality, risk management, and other policy scenarios might affect the quality and value of derivative investment products like the Apex CDS. The full disclosure of the Rums' Capital Allocation Choices, Information Quality, and the Cost of Capital in Lenz, C. and R. Verrecchia. 2005, Rums' Capital Allocation Choices, Information Quality, and the Cost of Capital. The Wharton School, University of Pennsylvania, URL: httn://fic.wharton.upenn.ecluffic/papers/04/0408.pdf, is incorporated by reference herein in its entirety.

In another example, the GRACE-CRAFT model supports a setting in which sell-side firms report their risk assessment metrics, analysis, and other valuation reasoning to the market. Reporting can be direct or via trusted agencies to safeguard competitive and other proprietary interests. Buy-side managers in this setting are able to independently assess and validate reported reasoning and, if they wish, counter with their own. In such a setting, when a trade is completed the established market value reflects both firms' reports back to the market. The quality of the reports, which includes independent assessment and verification, affects investment risk management decisioning. This, in turn, affects expected cash flows, cost of capital, and liquidity opportunities”. This setting supports the notions that reporting to capital markets play a crucial role in allocating capital and that the quality of information affects an agent's future net cash flows and capital liquidity opportunities.

Another Example of Application of the Invention: Managing Transaction Volumes

In our scenario, FIGS. 26 and 43-45, Bank of Trust organized the syndication of a 10 year corporate bond based on sound financial analysis of Apex Global Manufacturing. Now, fast forward five years. Apex's corporate bond has combined with other companies' debt and resold in three tranches to investors in several countries. How do the various lending institutions that organized these other companies' bond issuances know if Apex is in compliance with the covenants governing its own bond? What will the effect be on their own balance sheet if Apex defaults? How does Hopkins Hedge Fund or Bank of Trust know if either party sells their respective linked assets to other parties?

Obviously corporate performance numbers and rankings are available from such sources such as EDGAR, S&P and Moody's. Regular audits can be very effective for monitoring compliance requirements and asset ownership transfers. The problem is that the availability of sufficient time and expert resources manual audits justifiably require is not always compatible with the efficient market requirements. This is exacerbated in real time global market environments where multinational policy and jurisdiction issues can further complicate manual audit practices.

The sheer number of bonds makes it too costly to manually monitor the financial performance of the companies that secured the bonds. Similarly, the sheer number of CDSs makes it impossible to monitor the performance of the bonds being insured with CDSs. Both instruments, bonds and CDSs, can be and are traded independently to third parties in multiple markets governed by multiple jurisdictions and related polices. The result is a lack of timely information on the performance of the underlying corporations.

Next as stated earlier the modeler will want to use “use cases” as a means to drive requirements for known data attributes, policies, etc. to build from here the knowledge base in this context of the CDS business domain which becomes the ontology for the model. The following examples describe how the financial performance of a company can be tracked and reported and how the transfer of a bond from one bank to another can be tracked and reported.

Another Example of Applying the Invention: Monitoring the Health of Apex Global Manufacturing Corp.

In our scenario, FIGS. 26 and 43-45, Bank of Trust issued the bond based on sound financial analysis of Apex Global manufacturing Corp. that included the following information:
Credit rating: BBB
Quick ratio: 0.8
Debt to equity: 1.34

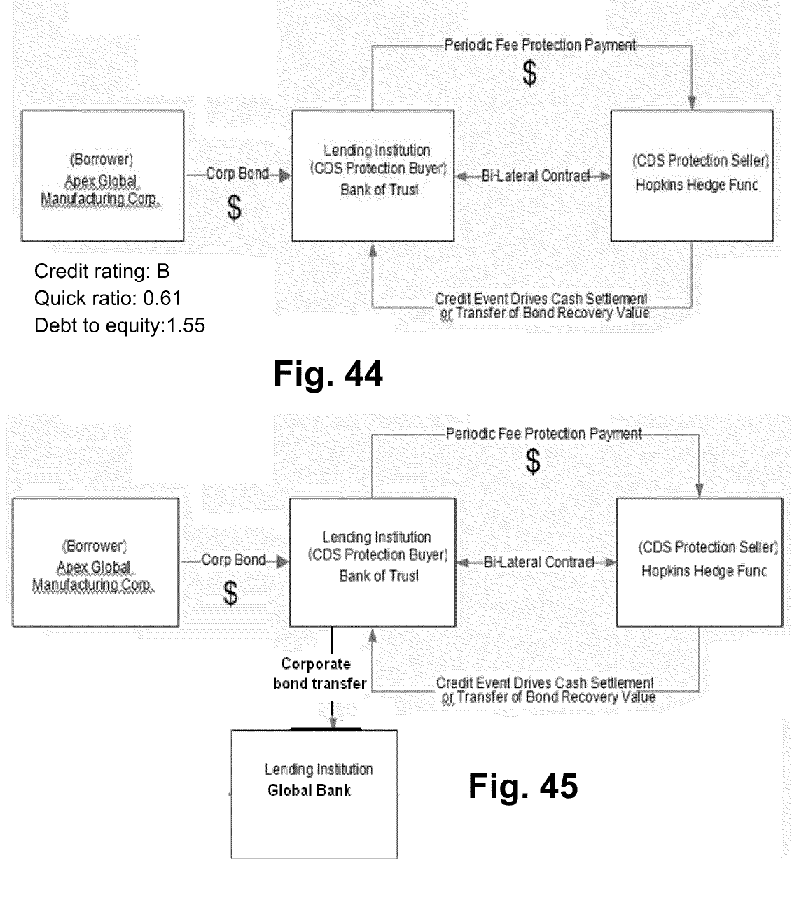

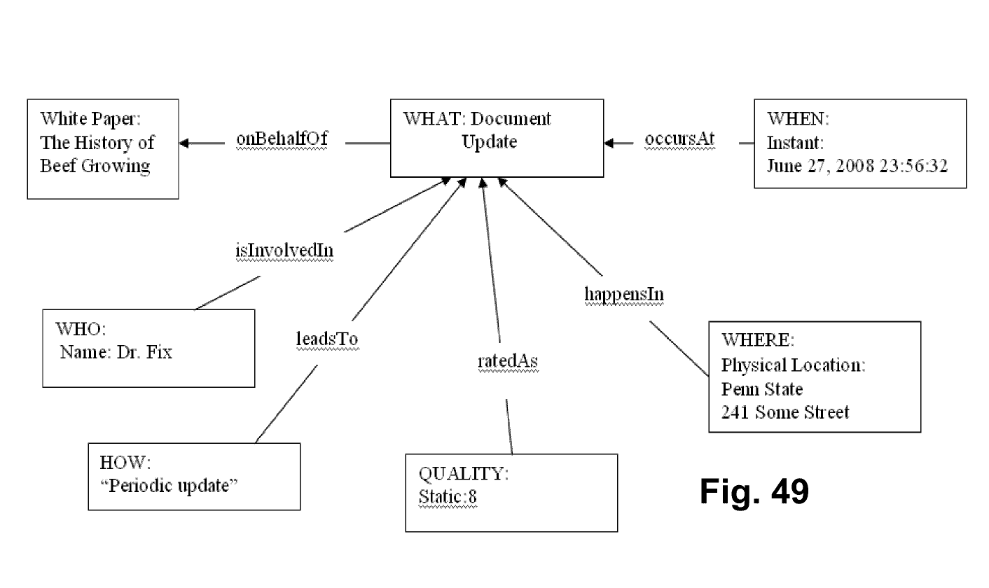

Well consider this to be Time 0 as shown in FIG. 49. Now last forward three months to Time 1 as shown in FIG. 44. How does the lending institution know if the company is still performing as well as when it first issued the bond? Does the information on the CDS reflect current states of the entities involved?

In another example, the modeler ideally would monitor the financial statements of Apex Global Manufacturing as well as it's Standard & Poor's credit rating, as example. Then he or she would use this information and apply the policies defined for the modeled system. For example, the policies might include:
If a company's credit rating falls below B (or a 5.30% probability of default—S&P Fitch scale), report the findings.
If a company's quick ratio falls below 0.65, report the findings.
If a company's debt to equity ratio changes more than 15.67% from previous period and quick ratio is below 0.65, report the findings

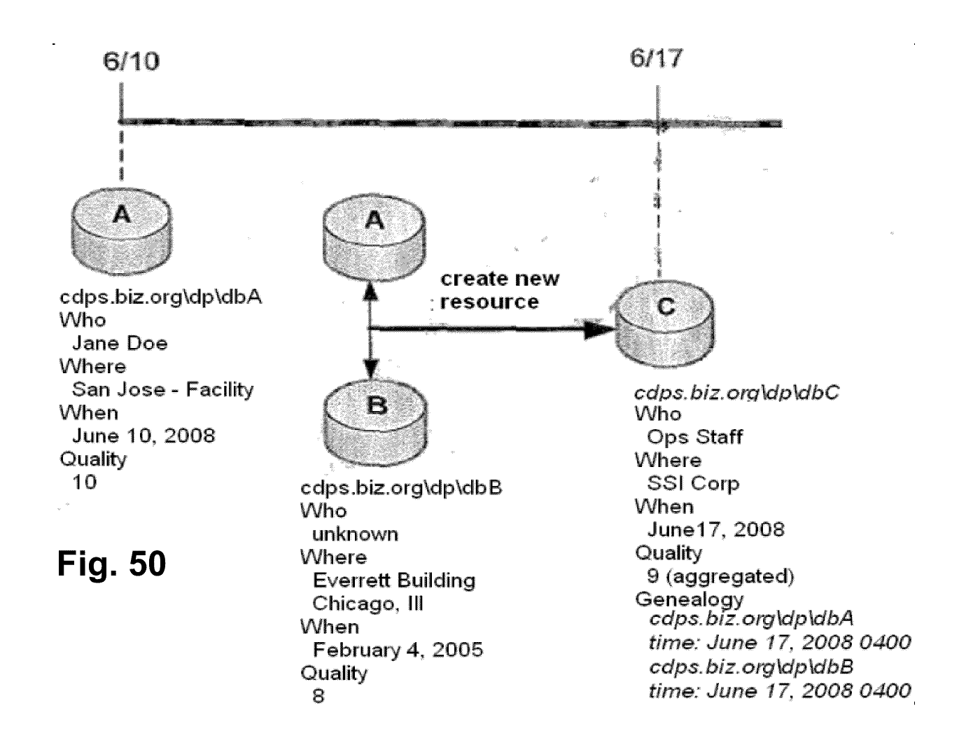

As shown in FIG. 50, Apex Global Manufacturing shows the following financial results:
Credit rating: 13
Quick ratio: 0.61
Debt to equity: 1.55

Based on the policies, the model will report the change in the credit rating from BBB to B, and the fact that the quick ratio changed more than 23.27% along with a significant increase of 15.67% in debt to equity ratio. The application will perform the same analysis for all companies issued bonds. The same type of service would be provided to the protection seller to ensure they are aware of changes that impact their level of risk. The information can be delivered as reports, online, or other format as required by the institutions.

Another Example of Applying the Invention: Tracking Changes Over Time

Now jump ahead two years to Time 2. Bank of Trust transfers the corporate bond to Global Bank as shown in FIG. 45. Under current conditions, the transfer may or may not be made known to the protection seller. It now becomes more difficult for the seller to assess the risk associated with the bond. The protection seller may have broken a portfolio of CDSs up and sold them to other markets to transfer risks.

A based on a policy that states:
If a lender transfers a bond to another institution, owners of CDSs that include the bond will be notified.

The use cases developed in this application context help the modeler identify the business processes, actors, data process policy driven attributes, etc. needed to continue the model setup for simulation. The results then are considered the knowledge base discovery building blocks for the GRACE-CRAFT model instance.

Another Example of Grace-Craft Model that Utilizes Building Blocks of Ontologies, Policies, and Data Provenance Attributes

Based upon the use case descriptions and diagramming above the modeler discovers important knowledge aspects of the specific business domain model. This collection then can be attached to the ontological representation which becomes the knowledge base of the GRACE-CRAFT model instance. The GRACE-CRAFT model is built around an ontology describing the elements in the system, policies describing how the system should behave, and data provenance tracking the state of the system at any given point in time. Each of these components is described in more detail below.
Ontology. An ontology describes the elements that make up a system, in this case the CDS landscape, and the relationships between the elements. The elements in the CDS system include companies, borrowers, lenders, investors, protection sellers, bonds, syndicated funds, credit ratings, and many more. The ontology is the first step in describing a model so that it can be represented in a software application.

The relationships might include the following:
Borrowers apply for bonds
Lenders issue bonds
Syndicated funds provide money to lenders
Lenders enter bi-lateral agreements with protection sellers.
Policies. Policies define how the system behaves. Policies are built using the elements defined in the ontology. For example:
   A company must be incorporated to apply for a bond.
   A company must have a certain minimum financial rating before it can apply for a bond.
   A bond can only be issued for a value greater than $1 million.
   The value of a bi-lateral agreement must not exceed 90% of the cash value of the bond.
   A company's credit rating must not fall below CCC.
   A company's quick ratio must remain above 0.66 and debt to equity must be below 1.40.
   A company's debt to equity ratio should not change by more than 15% from last quarter measured.
   If a lender transfers a bond to another institution, owners of CDSs that include the bond will be notified.

Policies are based on the elements defined in the ontology, and provide a picture of the expected outcomes for the system. Policies are translated in to rules that can be understood by the modeler or a software application. While it may take several hundred data attributes and policies to accurately define a real-world system, a modeler may choose a subset that applies to an experimental focus of the system.
Data provenance. Data provenance tracks the data in the system as it changes from one point in time to another. For example, the financial rating of a corporation as it changes from month to month. Or the elements that make up a CDS such as the quality of the information that describes the instrument.

Data provenance becomes important when expectations do not match outcomes. Data provenance provides the means to track possible causes of the discrepancy by allowing an analyst or auditor to reconstruct the events that took place in the system. More important, being able to trace the provenance of data quality across generations of derivative products can provide forewarning of potential problems before those problems are propagated any further.

### Another Example of Applying the Invention: Bringing Transparency to the Credit Default Swap Market

The GRACE-GRAFT model may enable lending institutions and protection sellers to closely model and simulate the effectiveness of data and derivative information risk assessments which drive more efficient risk management decisioning and investment. GRACE-CRAFT modeling also promises to provide early warning of brewing trouble as business environments, regulations, other policies change over time. Finally, GRACE-CRAFT modeling may provide analysts and policy makers with important insights into the relative effectiveness of alternative policies for achieving a defined objective.

### Another Example Of GRACE-CRAFT Model—Simple Supply Chain Model, Simplifying the Math

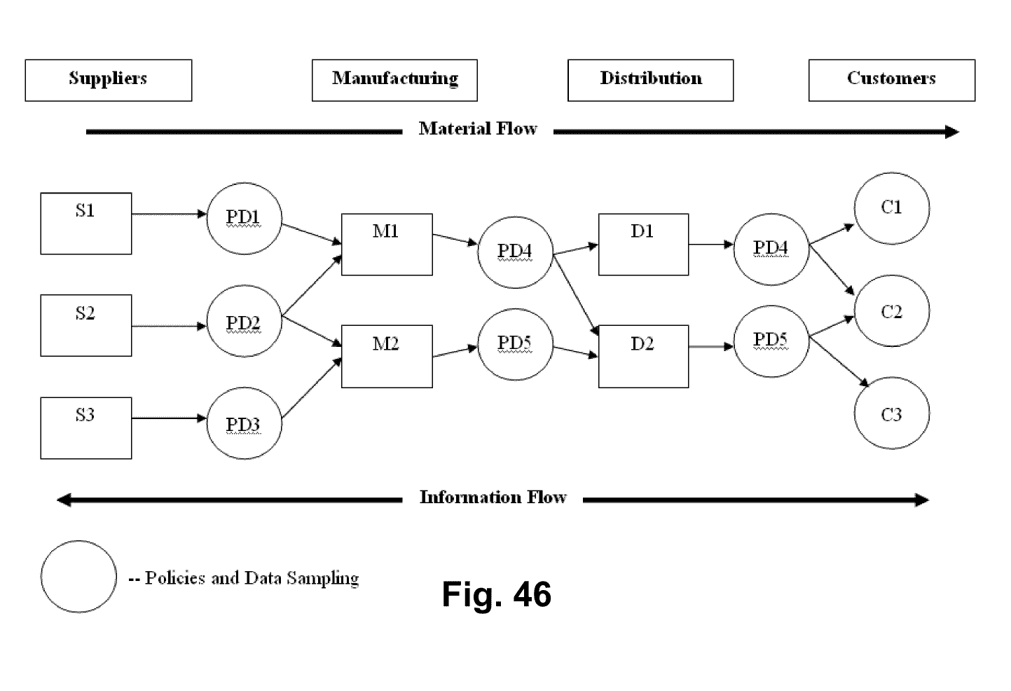

Another example of the GRACE-CRA1-model is presented in the context of a simple economy supply chain as shown in FIG. 46. The diagram displays entities identified with respective identification labels. Apex Global Manufacturing Corporation as define previously, is used as an entity in this example to demonstrate that this example of GRACE-CRAFT model can link business domains or ontologies in this case such that both policy driven data and processes can be tracked and trace over time.

This example uses the same business entity, Apex Global Manufacturing Corporation that is used in the CDS example. In this example, the GRACE-CRAFT model is used to model strategically link information value chains and information quality tracking across multiple domains. This example shows how the quality of data used to model Apex's manufacturing domain of activity impacts the quality of data used to model aspects of its financial domain of activity. This example shows how the attention to data quality in two key domains of company activity can directly impact the value of the products it manufactures with this data in each domain of its activities—and thus directly impacts the value of the company itself.

This example shows how the company's operational financial performance data, which is derived from data interactions in its supply chain domain of activity, can be linked to the data products and information risk assessments produced in its financial domain of activity. Financially linked parties will be naturally interested in the provenance and quality of financial performance data relating to Apex Global Manufacturing Corp.

With this linkage established, data—and the polices governing its quality and provenance—becomes more transparent across market specific boundaries.

46 is a entity diagram of a typical manufacturing supply chain. In this example we demonstrate how a modeler samples data from different sources in the supply chain to model and monitor how different events might impact the quality of that data; and subsequently the quality of supply chain operations. In this context the quality of the data reflects the quality of the supply chain operations and the data sources become virtual supply chain quality data targets that define the dimensions of the GRACE-CRAFT model. The quality of the data attributes imbedded in the information layer reflects the quality of the physical material and processes the parallel production, transportation, regulatory, and other layers of the physical supply chain. With the choice of data target nodes selected, the GRACE-CRAFT model can be reduced to a computational form. This example is modeled for purposes of simulation and as such its function is to guide, not to dictate; to illuminate assumptions, assertions, and consequences of policy on data quality or other attributes of interest. It is intended to support efficient simulation and assessment of the effectiveness of polices governing, among other things, data quality, and processes used to create, use, and distribute data and derivative products to do work in this simple supply chain representation. The reader will realize the example can become very large computationally if the modeler chooses larger sets of entities, data nodes, events and policies to experiment with. Stakeholders can use this model to track data provenance through generations of derivative works. Data provenance tracing and assurance is a key concept and functional capability of this model's application to a simple supply chain and the application mechanism it supports.

FIG. 46 represents a simple entity relationship diagram of how the modeling principles described in above can be applied to modeling and simulating the effectiveness of polices governing Apex's global supply chain data, and how that affects the operational and completive efficiency of the physical supply chain itself.

FIG. 46 shows a simple supply chain with identified data nodes (PD1 PD7) distributed at key informational target points defined from requirements of the system model.

Another Example of GRACE-CRAFT Model:

The GRACE CRAFT Model is calculated from an equation shown in (eqn. 11.) below.

$${G}_{ɛ} := ( {V}_{ɛ} , {E}_{ɛ} ) \to {\int }_{ɛ} [ G [ α , β , \frac{Δ}{Δɛ} Γ [ P ( {A}_{α} , {A}_{β} , Π , {Z}_{π} ) , D ( {R}_{A} , {Q}_{A} ) ] ] ] \partial ɛ \pm {\int }_{ɛ - 1} [ Min Max [ {\int }_{k} [ K ( α , β , \frac{\partial }{\partial ɛ} Γ ) ] \partial k ] ] \partial ɛ \qquad ( eqn . 11. )$$

A transformation of (eqn. 9.) into a form of practical application for a computational system is developed by first expressing the model as:

$${G}_{ɛ} := ( {V}_{ɛ} , {E}_{ɛ} ) \to {\sum }_{ɛ} [ G [ α , β , \frac{ΔΓ}{Δɛ} [ P ( {A}_{α} , {A}_{β} , Π , {Z}_{π} ) , D ( {R}_{A} , {Q}_{A} ) ] ] ] \pm {\sum }_{ɛ - 1} [ Min ( ) , Max ( ) {\sum }_{k} [ K ( α , β , \frac{Δ}{Δɛ} Γ ) ] ] \qquad ( eqn . 12. )$$

Entropy frictions α and β are known to operate on the set A_{α} and A_{β} randomly. Making this assumption one could choose to apply a statistical approach to random changes for the values of A_{α} and A_{β} over time. Of course a logical guess is needed for initial values. It is assumed highly probable entropy effects in A_{α} and A_{β} is small in magnitude for small time segments and is real and measurable. We assume unpredictable Knightian uncertainties low probability random influences that affect large scale magnitude changes to A_{α} or A_{β} independently are valid and can be modeled statistically as well, depending on model design and requirements.

Either statistically or probabilistically these entropy functions can be modeled as finite differences for a set of events although not changed by these events as define earlier.

α(A_{α})=Probability function denoting the probability of a change in A_{α}±ΔA₆₀
β=β(A_{β})=Probability function denoting the probability of a change in A_{β}±ΔA_{β}
Agents must consider a range of probability models in which to apply to specific business concepts, the ontology defined in (eqn. 11.)
The Continuous Compliance Assessment Utility function can be simplified for purposes of practical application as:

$$\frac{ΔΓ}{Δɛ} [ P ( {A}_{α} , {A}_{β} , Π , {Z}_{π} ) , D ( {R}_{p} , {Q}_{p} ) ] = [ \begin{matrix}\frac{Δ P}{Δɛ} ( {A}_{α} , {A}_{β} , Π , {Z}_{π} ) , \\ \frac{Δ D}{Δɛ} ( {R}_{A} , {Q}_{A} )\end{matrix} ] \qquad ( eqn . 13. )$$

### Carrying the

$$\frac{Δ}{Δɛ}$$

into the Data Process Policy function yields,

$$\frac{Δ P}{Δɛ} = ( \frac{Δ {A}_{α}}{Δɛ} , \frac{Δ {A}_{β}}{Δɛ} , Π , {Z}_{π} ) , \qquad ( eqn . 14. )$$

And similarly with die Data Provenance function,

$$\frac{Δ D}{Δɛ} = ( \frac{Δ {R}_{A}}{Δɛ} , \frac{Δ {Q}_{A}}{Δɛ} ) , \qquad ( eqn . 15. )$$

where the Recording and Querying functions are functions of ΔA_{α} and ΔA_{β} respectively. This means the functions are used only when a change in attribute is measured. These functions act to store and retrieve changes in A_{α} and A_{β} as matrix arrays.
The Continuous Compliance Objective function is represented as,

$$\pm {\sum }_{ɛ - 1} [ Min ( ) , Max ( ) {\sum }_{k} [ K ( α , β , \frac{Δ}{Δɛ} Γ ) ] ]$$

Bringing all terms hack into the full model:

$${G}_{ɛ} := ( {V}_{ɛ} , {E}_{ɛ} ) \to {\sum }_{ɛ} G [ α ( {A}_{α} ) , β ( {A}_{β} ) , ( \frac{Δ {A}_{α}}{Δɛ} , \frac{Δ {A}_{β}}{Δɛ} , Π , {Z}_{π} ) , ( \frac{Δ {R}_{p}}{Δɛ} , \frac{Δ {Q}_{p}}{Δɛ} ) ] \pm {\sum }_{ɛ - 1} [ Min ( ) , Max ( ) [ {\sum }_{k} K [ ( α ( {A}_{α} ) , β ( {A}_{β} ) , ( \frac{Δ {A}_{α}}{Δɛ} , \frac{Δ {A}_{β}}{Δɛ} , Π , {Z}_{π} ) , \frac{Δ}{Δɛ} ( \frac{Δ {R}_{p}}{Δɛ} , \frac{Δ {Q}_{p}}{Δɛ} ) ) ] ] ] \qquad ( eqn . 12. )$$

Representing elements of (eqn. 16) as a matrix set yields,

G̅=[ΔĀ_{α},ΔĀ_{β},Δ P̅,Δ D̅]± K̅_{min max}=[ΔĀ_{α},ΔĀ_{β},Δ P̅,Δ D̅] (eqn. 17.)

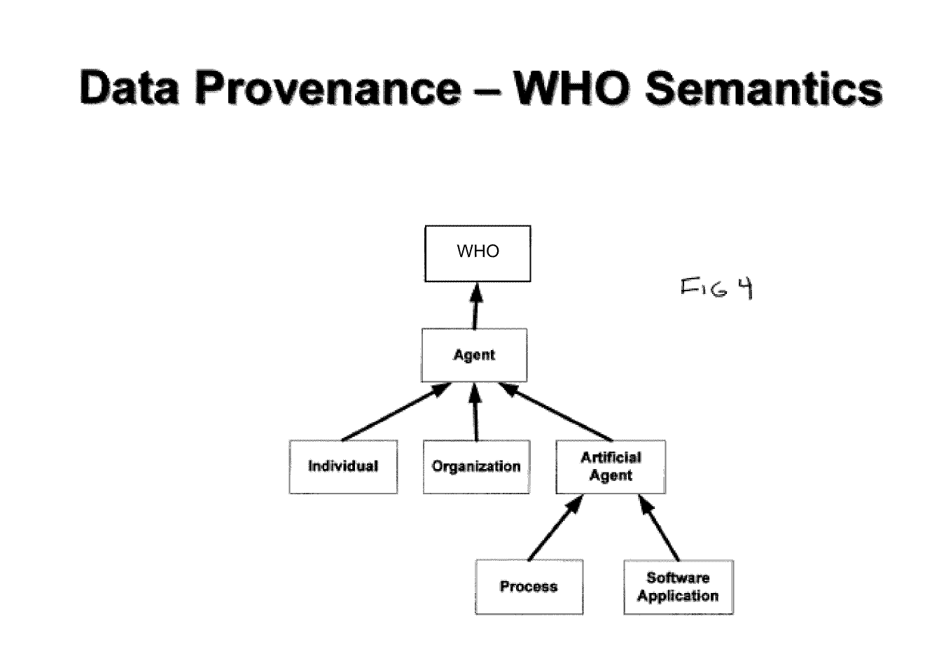

As example for a single arbitrary measurable event ε₁, assuming only (1) attribute, (1) policy, and (1) obligation per sensor node for the nodes PD1, PD4, PD6, PD7 as shown in FIG. 4., the matrix set in (eqn. 17.) can be expanded into its respective elements as,
(Degrees of freedom, DOF=(4) for the data target set)

$$[ \begin{matrix}{a}_{{α}_{1}}^{α} \\ {a}_{{α}_{2}}^{α} \\ {a}_{{α}_{3}}^{α} \\ {a}_{{α}_{4}}^{α}\end{matrix} ] , [ \begin{matrix}{a}_{{β}_{1}}^{β} \\ {a}_{{β}_{2}}^{β} \\ {a}_{{β}_{3}}^{β} \\ {a}_{{β}_{4}}^{β}\end{matrix} ] , [ \begin{matrix}{a}_{{α}_{1}}^{{ɛ}_{1}} & {a}_{{β}_{1}}^{{ɛ}_{1}} & {π}_{1}^{{ɛ}_{1}} & {z}_{{π}_{1}}^{{ɛ}_{1}} \\ {a}_{{α}_{2}}^{{ɛ}_{1}} & {a}_{{β}_{2}}^{{ɛ}_{1}} & {π}_{2}^{{ɛ}_{1}} & {z}_{{π}_{2}}^{{ɛ}_{1}} \\ {a}_{{α}_{3}}^{{ɛ}_{1}} & {a}_{{β}_{3}}^{{ɛ}_{1}} & {π}_{3}^{{ɛ}_{1}} & {z}_{{π}_{3}}^{{ɛ}_{1}} \\ {a}_{{α}_{4}}^{{ɛ}_{1}} & {a}_{{β}_{4}}^{{ɛ}_{1}} & {π}_{4}^{{ɛ}_{1}} & {z}_{{π}_{4}}^{{ɛ}_{1}}\end{matrix} ] , \\ [ \begin{matrix}( {a}_{{α}_{1}}^{α} , {a}_{{β}_{1}}^{β} , {a}_{{α}_{1}}^{{ɛ}_{1}} , {a}_{{β}_{1}}^{{ɛ}_{1}} ) & ( {a}_{{α}_{1}}^{{α}_{n}} , {a}_{{β}_{1}}^{{β}_{n}} , {a}_{{α}_{1}}^{{ɛ}_{n}} , {a}_{{β}_{1}}^{{ɛ}_{n}} ) \\ ( {a}_{{α}_{2}}^{α} {a}_{{β}_{2}}^{β} , {a}_{{α}_{2}}^{{ɛ}_{1}} , {a}_{{β}_{2}}^{{ɛ}_{1}} ) & ( {a}_{{α}_{2}}^{{α}_{n}} {a}_{{β}_{2}}^{{β}_{n}} , {a}_{{α}_{2}}^{{ɛ}_{n}} , {a}_{{β}_{2}}^{{ɛ}_{n}} ) \\ ( {a}_{{α}_{3}}^{α} {a}_{{β}_{3}}^{β} , {a}_{{α}_{3}}^{{ɛ}_{1}} , {a}_{{β}_{3}}^{{ɛ}_{1}} ) & ( {a}_{{α}_{3}}^{{α}_{n}} {a}_{{β}_{3}}^{{β}_{n}} , {a}_{{α}_{3}}^{{ɛ}_{1}} , {a}_{{β}_{3}}^{{ɛ}_{n}} ) \\ ( {a}_{{α}_{4}}^{α} {a}_{{β}_{4}}^{β} , {a}_{{α}_{4}}^{{ɛ}_{1}} , {a}_{{β}_{4}}^{{ɛ}_{1}} ) & ( {a}_{{α}_{4}}^{{α}_{n}} {a}_{{β}_{4}}^{{β}_{n}} , {a}_{{α}_{4}}^{{ɛ}_{n}} , {a}_{{β}_{4}}^{{ɛ}_{n}} )\end{matrix} ] \pm [ \begin{matrix}{a}_{{α}_{1}}^{α - 1} \\ {a}_{{α}_{2}}^{α - 1} \\ {a}_{{α}_{3}}^{α - 1} \\ {a}_{{α}_{4}}^{α - 1}\end{matrix} ] , \\ [ \begin{matrix}{a}_{{β}_{1}}^{β - 1} \\ {a}_{{β}_{2}}^{β - 1} \\ {a}_{{β}_{3}}^{β - 1} \\ {a}_{{β}_{4}}^{β - 1}\end{matrix} ] , [ \begin{matrix}{a}_{{α}_{1}}^{{ɛ}_{1} - 1} & {a}_{{β}_{1}}^{{ɛ}_{1} - 1} & {π}_{1}^{{ɛ}_{1} - 1} & {z}_{{π}_{1}}^{{ɛ}_{1} - 1} \\ {a}_{{α}_{2}}^{{ɛ}_{1} - 1} & {a}_{{β}_{2}}^{{ɛ}_{1} - 1} & {π}_{2}^{{ɛ}_{1} - 1} & {z}_{{π}_{2}}^{{ɛ}_{1} - 1} \\ {a}_{{α}_{3}}^{{ɛ}_{1} - 1} & {a}_{{β}_{3}}^{{ɛ}_{1} - 1} & {π}_{3}^{{ɛ}_{1} - 1} & {z}_{{π}_{3}}^{{ɛ}_{1} - 1} \\ {a}_{{α}_{4}}^{{ɛ}_{1} - 1} & {a}_{{β}_{4}}^{{ɛ}_{1} - 1} & {π}_{4}^{{ɛ}_{1} - 1} & {z}_{{π}_{4}}^{{ɛ}_{1} - 1}\end{matrix} ] , \\ [ \begin{matrix}0 & ( {a}_{{α}_{1}}^{α - 1} , {a}_{{β}_{1}}^{β - 1} , {a}_{{α}_{1}}^{{ɛ}_{1} - 1} , {a}_{{β}_{1}}^{{ɛ}_{1} - 1} ) \\ 0 & ( {a}_{{α}_{2}}^{α - 1} {a}_{{β}_{2}}^{β - 1} , {a}_{{α}_{2}}^{{ɛ}_{1} - 1} , {a}_{{β}_{2}}^{{ɛ}_{1} - 1} ) \\ 0 & ( {a}_{{α}_{3}}^{α - 1} {a}_{{β}_{3}}^{β - 1} , {a}_{{α}_{3}}^{{ɛ}_{1} - 1} , {a}_{{β}_{3}}^{{ɛ}_{1} - 1} ) \\ 0 & ( {a}_{{α}_{4}}^{α - 1} {a}_{{β}_{4}}^{β - 1} , {a}_{{α}_{4}}^{{ɛ}_{1} - 1} , {a}_{{β}_{4}}^{{ɛ}_{1} - 1} )\end{matrix} ] . \qquad ( eqn . 18 )$$

If this is the first event recorded then the Objective functions observation is likely to be null matrix since there will be “zero event” history before beginning the model simulation. However based upon assumptions made for initial conditions and the time of actual computational sampling all entropy effects may be measurable and can be used to make correction before marching forward with more events and observations. The Data Provenance Querying function (and not the queried attributes contained in the Objective function) can be sampled for attribute values for any past event sampling and usually will be driven by policy as represented in (eqn. 16.).

The next steps of using this model are for the modeler to design the GRACE-CRAFT specific model application functions: The Event Forcing functions ε: The Entropy functions α and β: The Data Process Policy functions and their corresponding Obligation functions

$$\frac{Δ A α}{Δ ɛ} , \frac{Δ A β}{Δ ɛ} , \prod Z π .$$

The Data Provenance functions

$$\frac{Δ R ( A )}{Δ ɛ} , \frac{Δ Q ( A )}{Δ ɛ} .$$

Finally the range and initial conditions for these functions and all attributes must be defined or estimated to complete the design of the simulation.

The modeler may choose to design these functions empirically, statistically or probabilistically or be based upon existing real physical system models.

Yet Another Example of Applying the Invention.

In another example, the CCA Architecture defines the usage of Data Provenance such that it achieves the objectives of the business requires and does not limit future capability of its use. As this term used in context of this example, Data Provenance refers to the history of data including its origin, key events that occur over the course of its lifecycle, and other traceability related information associated with its creation, processing, and archiving. It is the essential ingredient that ensures that users of data (for whom the data may or may not have been originally intended) understand the background of the data This includes concepts such as, What (sequence of resource lifetime events), Who generated the event (Person Or Organization). Where the event came from (location), How the event transformed the resource, the assumptions made in generating it, and the processes used to modify it, When the event occurred (started/ended), Quality measure (used as a general quality assessment to assist in assessing this information, within the DATA policy governance) and Genealogy (defines sources used to create a resource). The use of Data Provenance in the CCA Architecture has many applications within a social business and legal context. Other examples of the application of Data Provenance is as follows.

Data, Quality: The lineage can be used via policy to estimate data quality and data reliability based on the (Who, Where) source of the information and the process (What, How) used to transform the information. The level of detail in the Data Provenance will determine the extent to which the quality of the data can be estimated. This information can be used to help the user of the data determine authenticity and avoid spurious data sources. Since a “trusted data information exchange” governed by policy provides a certified semantic knowledge of the Data Provenance, it is possible to automatically evaluate it based on Quality metrics that are defined and provide a “quality score”. Hence, the Quality element can be used separately or in conjunction with policy based estimations to determine quality. It can be considered the “authoritative” element for Data Quality.
Audit Trail: Data Provenance can be used to trace the audit trail of data, and determine resource usage, who has accessed information. The audit trail is especially important when establishing patents, or tracing intellectual property for business or legal reasons.
Attribution: Pedigree can establish the copyright and ownership of data, enable its citation, and determine liability in the case of erroneous use of data.
Informational: A generic use of Data Provenance lineage is to query base on lineage metadata for data discovery. It can be browsed to provide a context to interpret data.

Data Provenance Basic Actions

There are three basic actions performed on Data Provenance information, record, query, and delete. Record is the action by which data Provenance information is created and modified. Query provides a means to retrieve information from a Data Provenance store. The delete action removes information from a Data Provenance store.

Data Provenance Ontology

This section describes the classes that describe each data provenance concept and make up part of the Data Provenance ontology. The Data Provenance as used for each CCA Service Application may vary in accordance with future business requirements for Data Provenance.

What Semantics

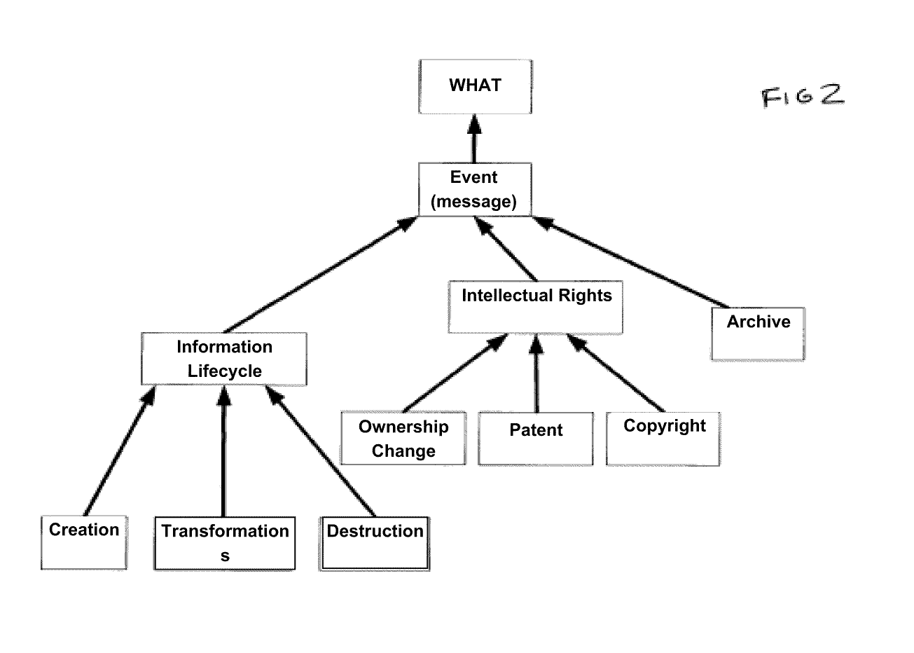

What, is a set of events (messages) capturing the sequence of events that affect the Data Provenance of a resource during its lifetime. What tracks the lifetime events that bring a resource into existence, modify its intrinsic or mutual properties or values, and its destruction and archiving. FIG. 2 shows how these events are categorized as information lifecycle, intellectual rights and archive. It is from the What that drives all operations for Record and Delete actions acting upon Data Provenance. Events are associated with message requests invoking the CCA policy. The Information Lifecycle events are solid concepts. These events are an example of events essential to Data Provenance.

Creation—specifies the time this resource came into existence. The creation event time stamp is placed in the When concept. The Where, What, Who and How may contain data from this event. There will be situations where Creation events will not occur for a resource but the resource nonetheless exists. A mechanism needs to be in place that create a resource simulating the Creation event.

Transformations—specifies when the resource is modified. The transformation event time stamp is placed in the When concept. The Where, What, Who and flow may contain data from this event.

Destruction—specifies when the resource is no longer tracked by Data Provenance. There will not be any removal of historic Data Provenance information. Data Provenance information for a given resource will be archived when an archive event occurs. From that point forward, information regarding the destroyed resource's Data Provenance will-be obtain via the archive.

Intellectual Rights are events dealing with actions, that require a change of ownership, patent or copyright. One can deduce that these events are a subtype of Transformations. However, transformations deal with a change of the resource whereas Intellectual Rights events are legal event signifying a change of ownership, patent, or copyright.

Archive is an event signifying the Data Provenance for a given resource that was moved from an active transactional state to the archive state. The archive state could mean a separate offline store or a store where different policy controls are in place.

When Semantics

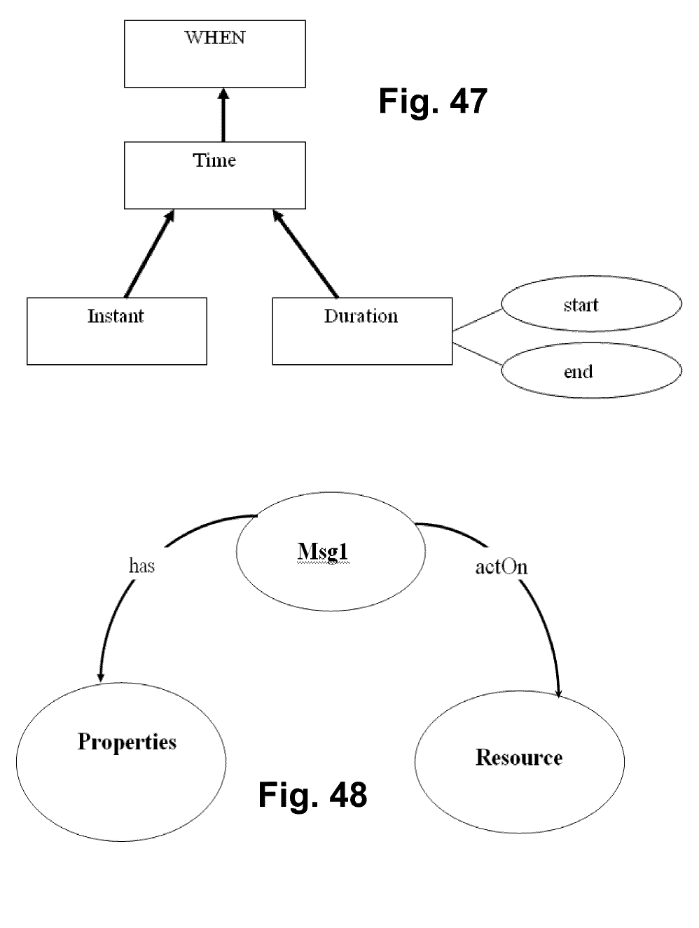

As shown in FIG. 47, When, represents a set of time stamps representing the time period during which a Data Provenance event occurred during the lifetime of the resource. Some events might be instantaneous while others may occur over an interval of time, hence there is a start and end time. The Time Instant is used when a single event does not specify a start or end of a duration period. For instance, a document being posted is a single Time Instant event. It happened at this time with no start or end period.

Where Semantics

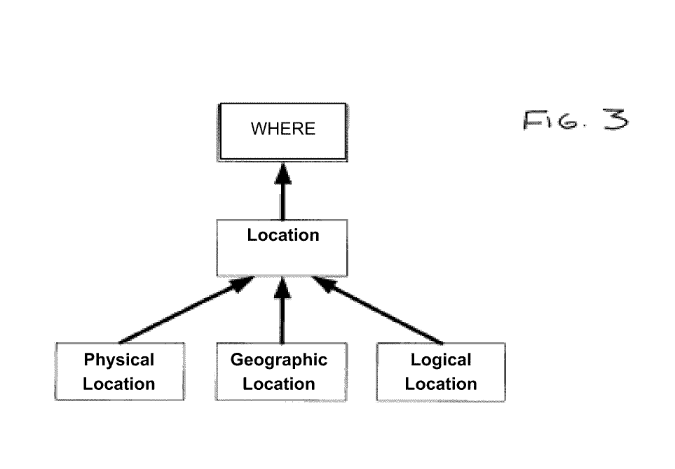

As shown in FIG. 3, Where, represents the location of where the various events originated. Physical location represents an address within a city, state, province, county, country, etc. The Geographical location represents a location based on latitude and longitude. The logical location link the resource to its URI location. This could be a database, a service interface, etc.

Who Semantics

As shown in FIG. 4, Who, refers to the agent who brought about the events. An agent can be a person, organization, or an artificial agent such as a process, or software application.

The Agent class is used “for attribution to determine who the owner of a resource.

How Semantics

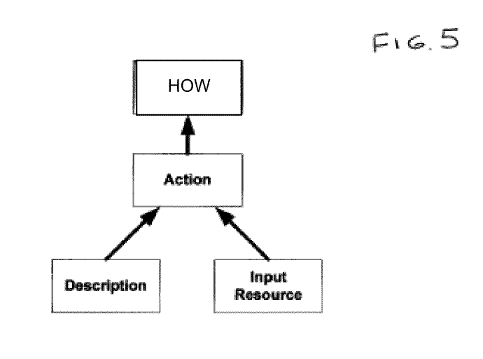

With respect to FIG. 5, How documents the actions taken on the resource. It describes how the resource was created, modified (transformed) or its destruction. If there are inputs required to say perform data correlation or fusing of more than one Data Source, the Input Resource define the input resources.

Quality Semantics

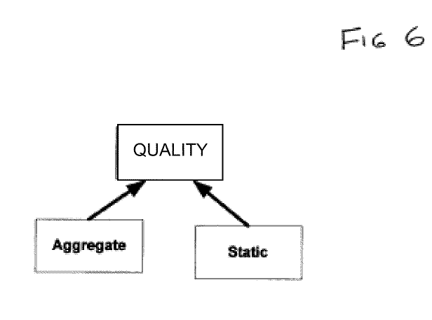

With respect to FIG. 6, Quality, is represented through policy driven aggregation or it is a single static value. The aggregate value is achieved by a policy defined algorithm which performs analysis on Data Provenance values as well as other resource information to determine the Quality Aggregate value. Perhaps the algorithm used to determine the aggregate value is defined in the policy. The Static preset value is a value achieved through human perception.

In another example, a Slot Exchange company had a quality aggregate that we based on feedback received from slot purchasing customers. The computer program of this invention, at some duration, would inspect all the feedback ratings and derive an up to date value for the slot trade rating for a company. There may be one or more Quality measures for any given resource. For instance, a science publication may have other quality measures such as Technical Content, Writing Skills, Scientific Accuracy, Number of Readers, Last Edit Date. These could be Static values set by someone or they could be Aggregate measures determined by policy.

Genealogy Semantics

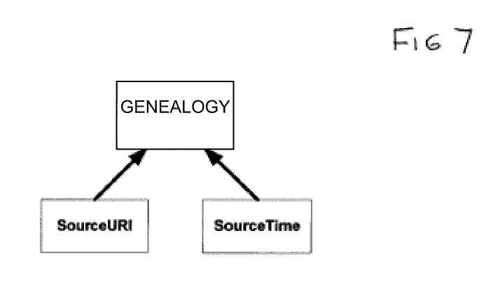

With respect to FIG. 7, The Genealogy concept provides the linkage to answer the question, what information sources' Data Provenance make up this resource's Data Provenance.

The Genealogy concept is only used when a resource^{c} consists of other resources which resources have Data Provenance information tracking capability on The SourceURI is a pointer to the Data Provenance of resource and consists of information obtained from this resource Source Time is the time that the source resource was used to construct the new resource.

There is an example of the use of this concept in the following section on Data Provenance Gene. It will help to understand the use of this concept.

Other Semantics

There are at least two ontology Semantics that can be associated with Data Provenance, Why and Which. Why describes the decision making rationale of an action on a given resource. Which describes the instruments of software applications used in creating or processing resource.

Data Provenance Graphs

FIG. 49 shows an example of Document Update Graph that illustrates the relationships of the What, When, Who, How, Where and Quality of a documented being updated. By reading this graph we can surmise the document “The History of Beet Growing” was updated on Jun. 27, 2008 by Dr. Fix. The update was performed at Penn State and has a quality rating of 8.

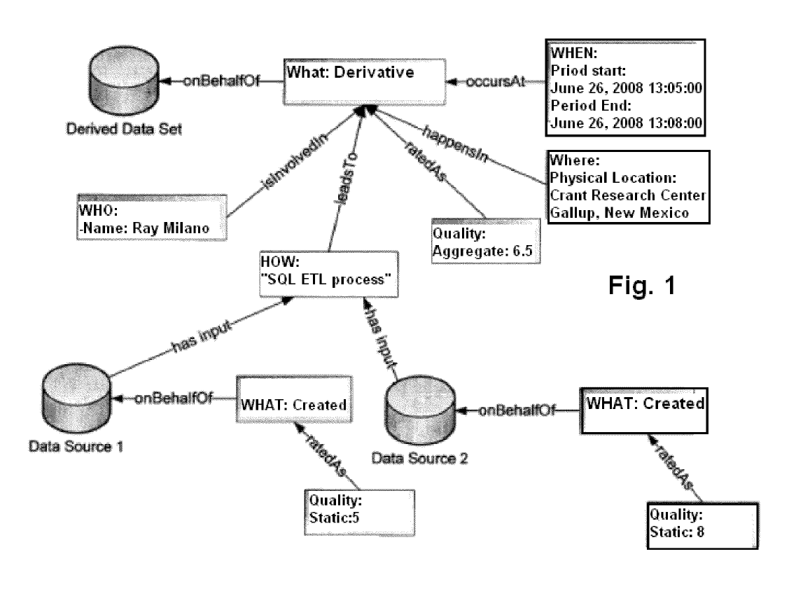

In another graph example, FIG. 1, Derivative Graph, shows a derivative Data Set being updated by a SQL ETL process which started on June 26^{th} at 1:051³M and completed at 1:08 PM in the Grant Research Center. This derivative Data Set has an aggregated Quality rating of 6.5 as this rating was aggregated by averaging the Data Source 1 and Data Source 2 static Quality metric.

Data Provenance Time Stamps

The Data Provenance record and delete actions require a time stamp. If there are multiple objects being created, updated, destroyed or archived, a time stamp is required for each object. This is not to infer a separate time stamped event for each object but rather a linking of all Data Provenance actions through a key to a single time stamp. This would be analogous to a foreign key in a RDBMS. This is probably stating the obvious but it is essential for auditing and Data Quality algorithms.

Data Provenance and CCA Service Application Relationships

A CCA Service Application has a set of ontologies that describe the application domain which contains a set of resources and rules which govern the behavior the application. Initially a resource defined in the ontology does not have Data Provenance associated with the resource. The invention provides a mechanism to associate the Data Provenance ontology to a CCA Application resource. A relationship between the resource, message and data provenance is required to set in play any record or delete action for Data Provenance. The CCA Service Application execution is driven by receiving messages (events) and executing policy (rules) which contain the going business logic. Not all CCA Service Applications will r require to track Data Provenance. In another example, the Data Provenance capability is optional. Perhaps from a licensing perspective it will be a feature. Once it is decided that a business requires Data Provenance, the analyst will need to decide which resources defined by the CCA Service Application's ontologies will require Data Provenance information and what data properties are required, etc. A relationship between the business domain resource and the Data Provenance classes can be used to represent the relationship.

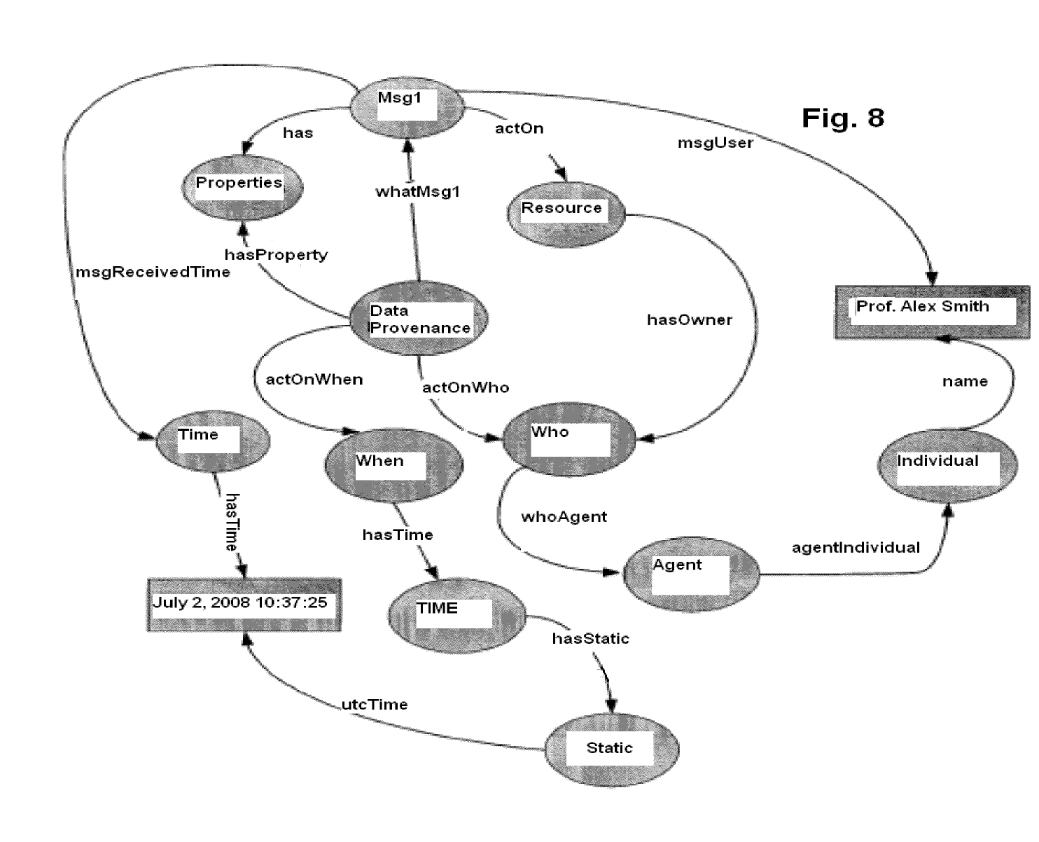

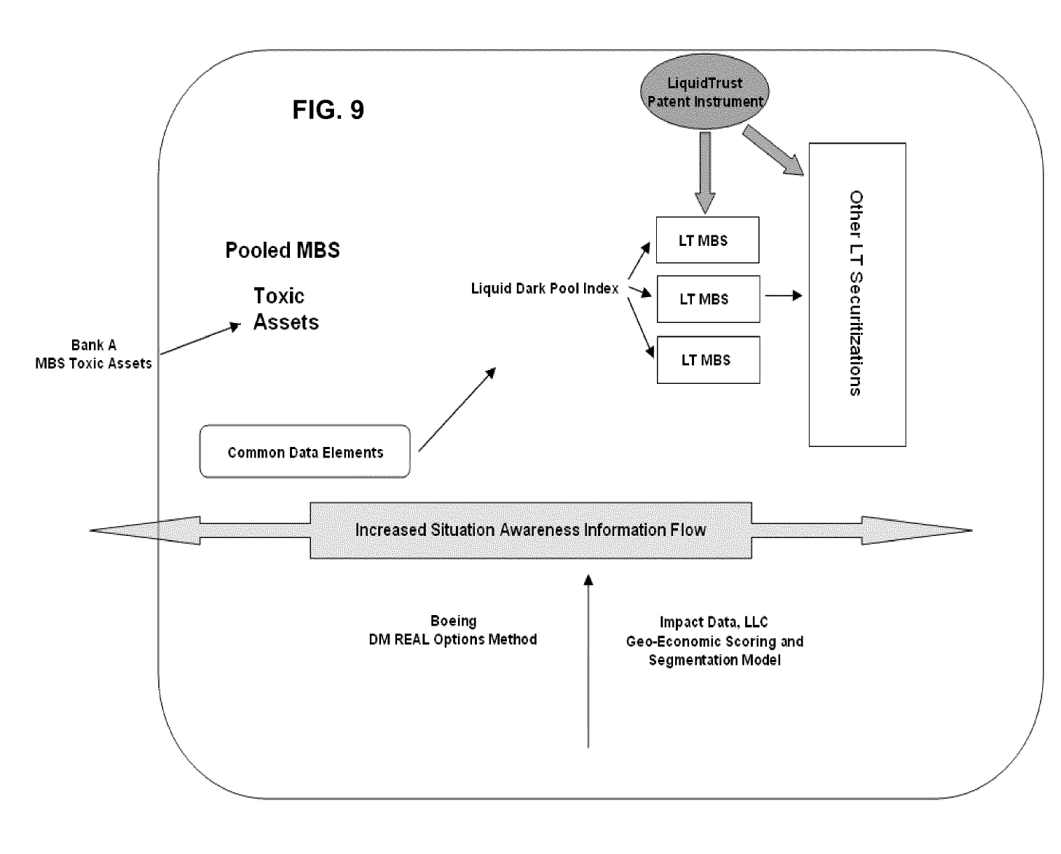

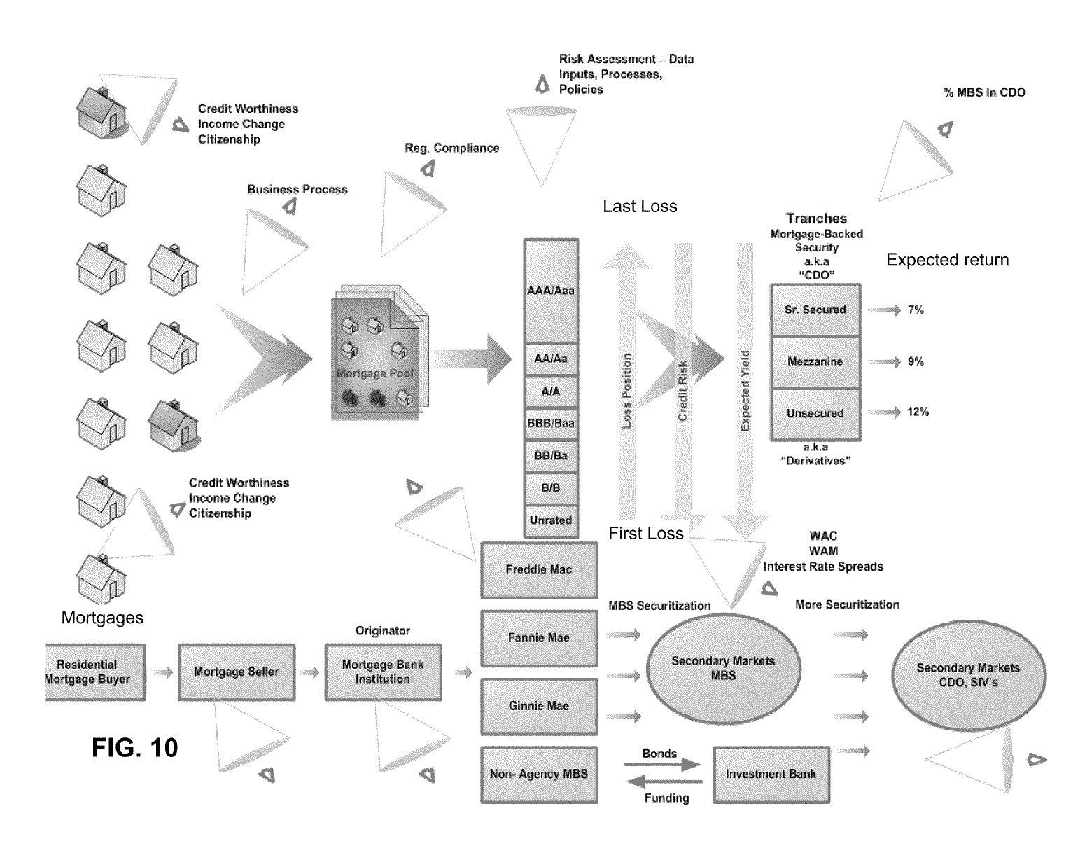

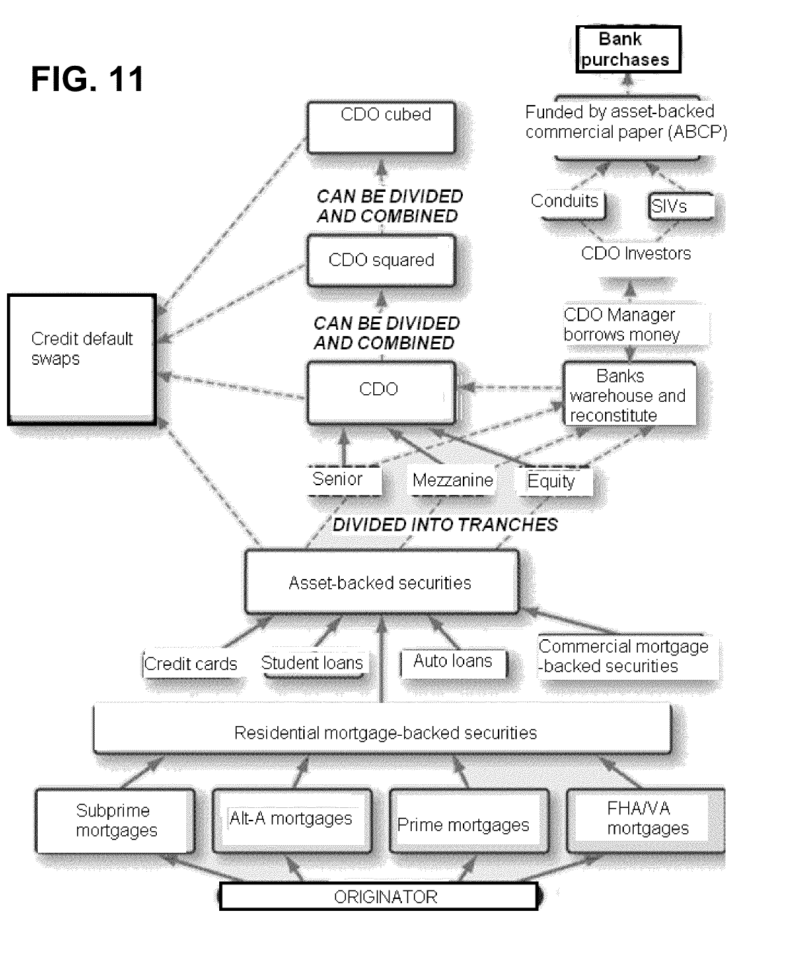

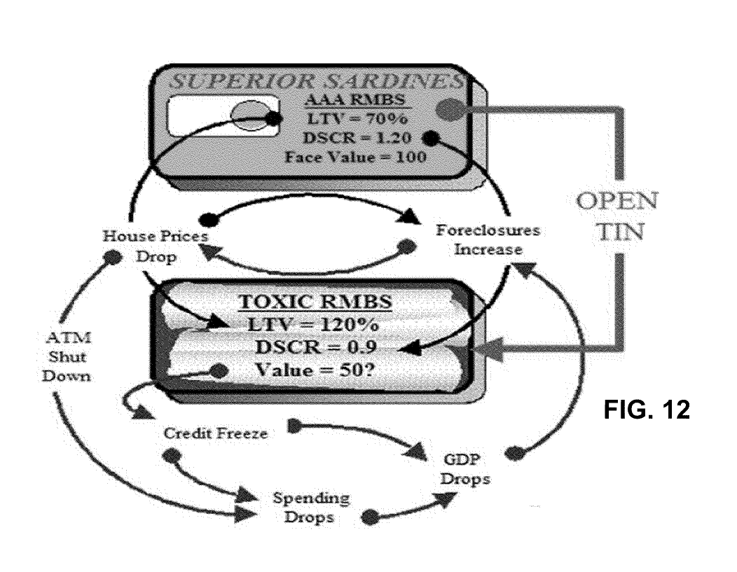

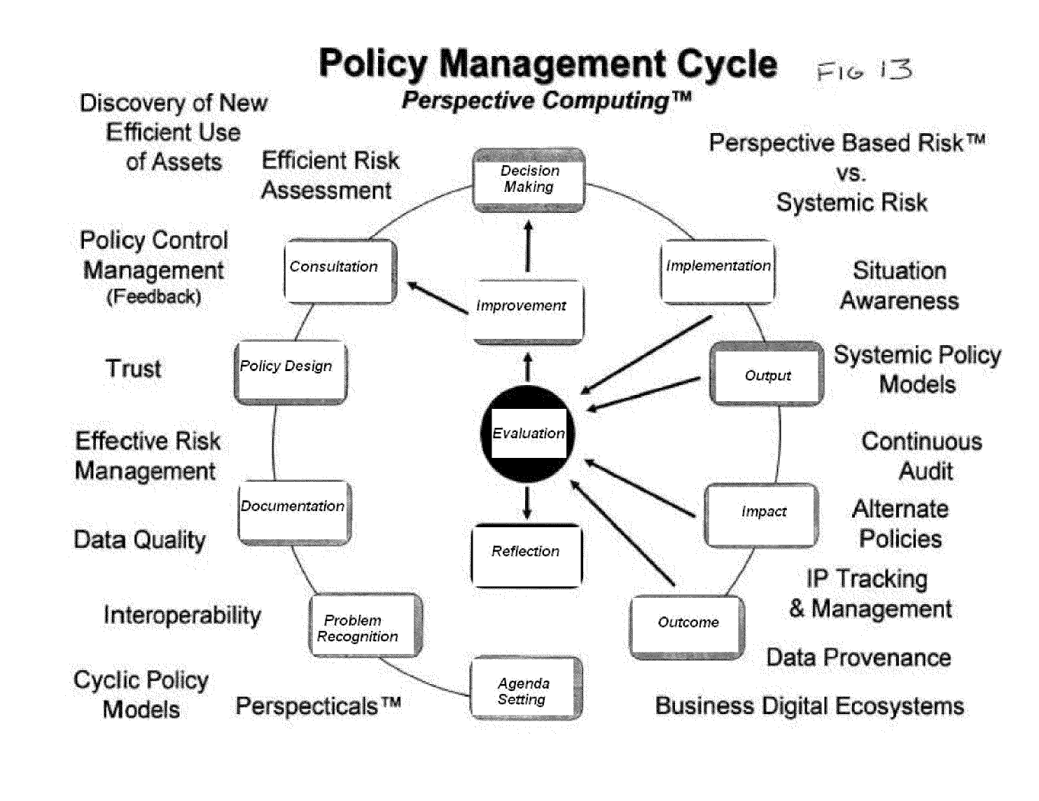

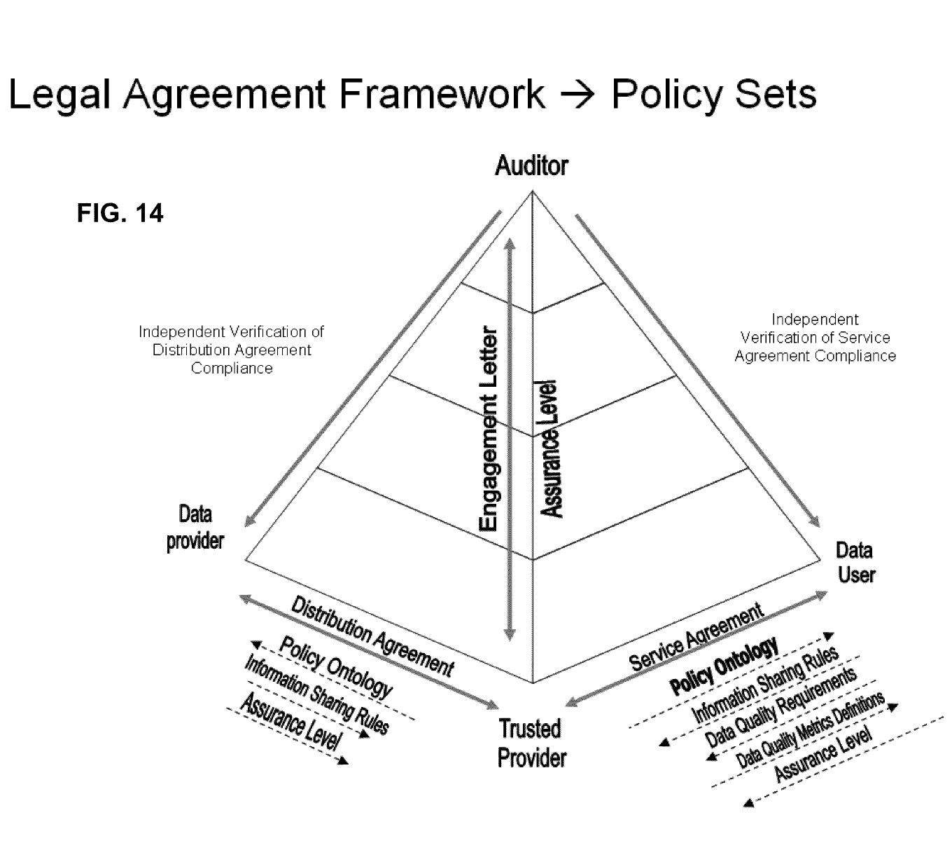

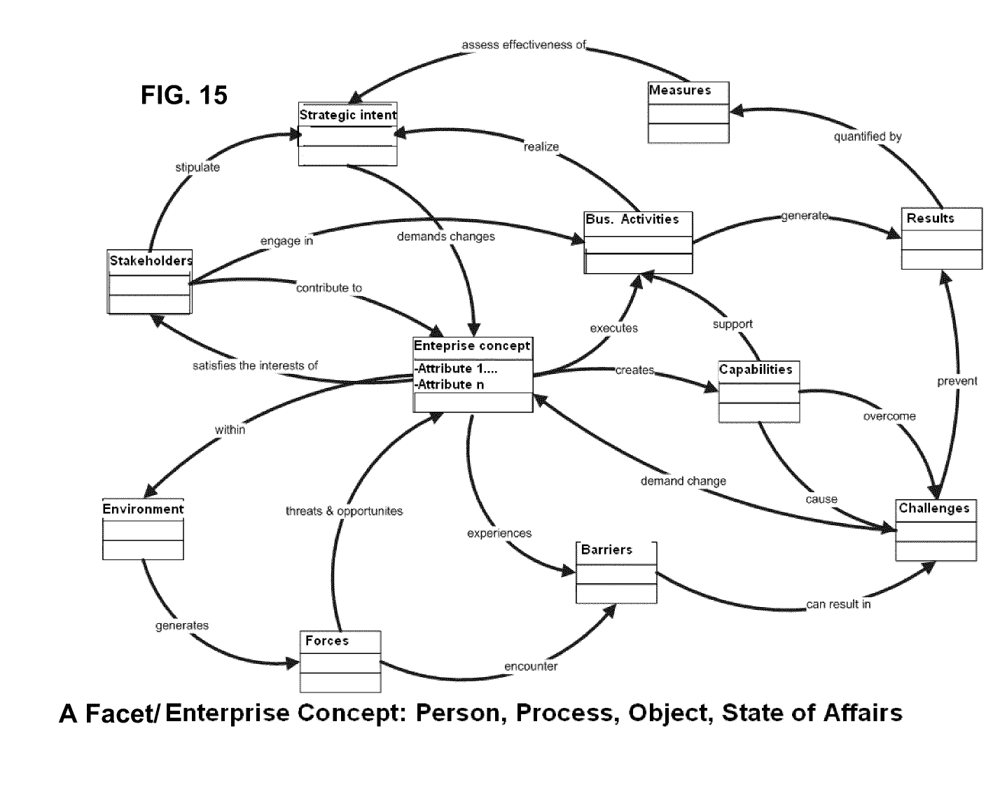

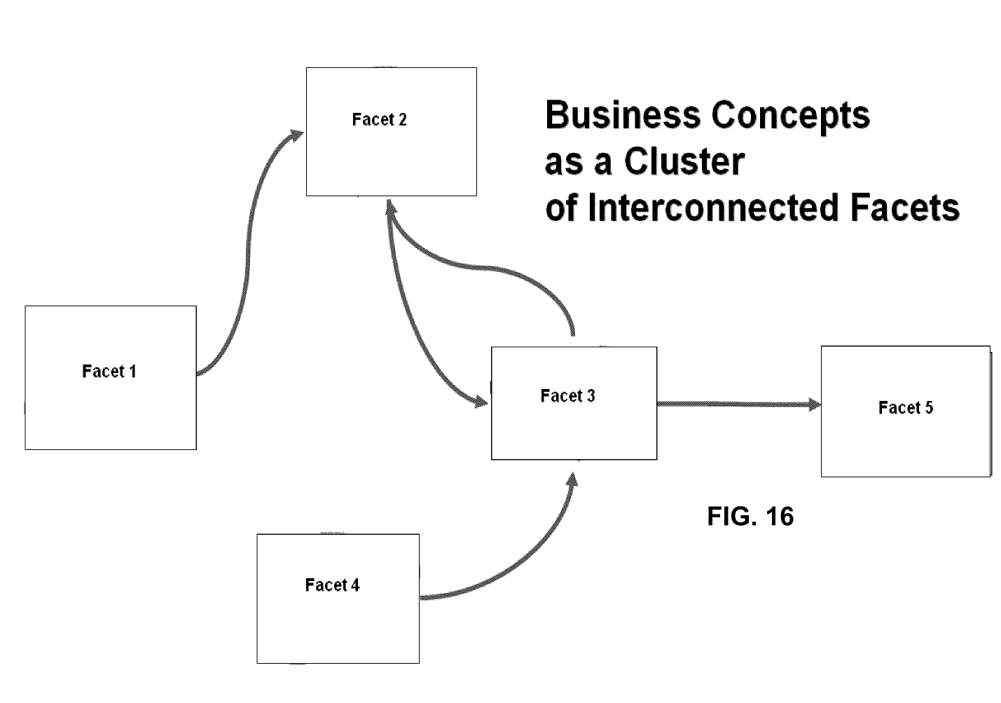

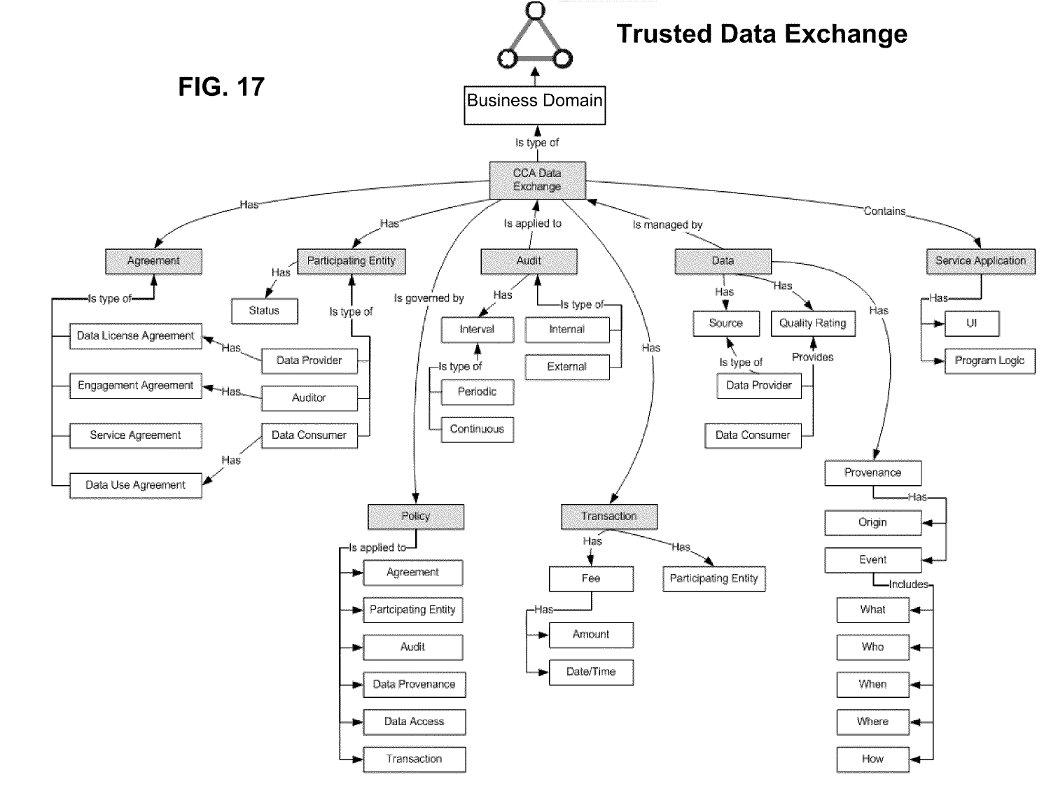

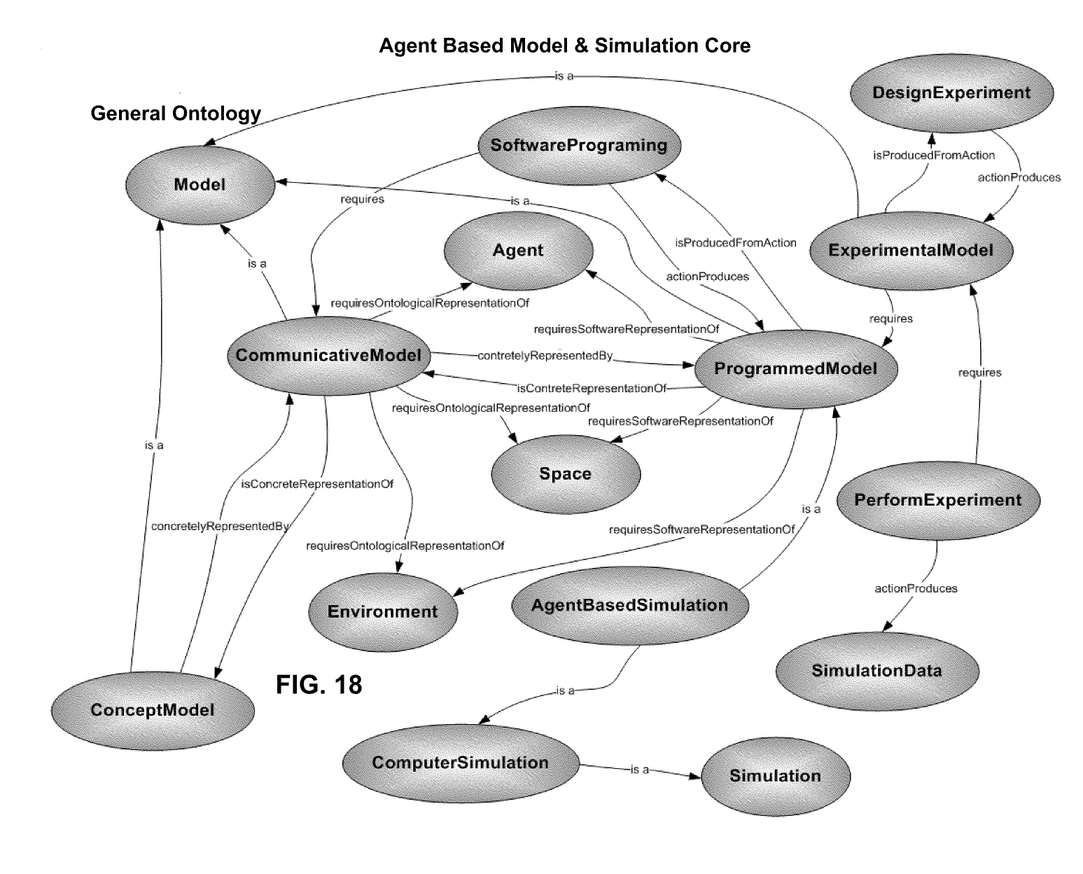

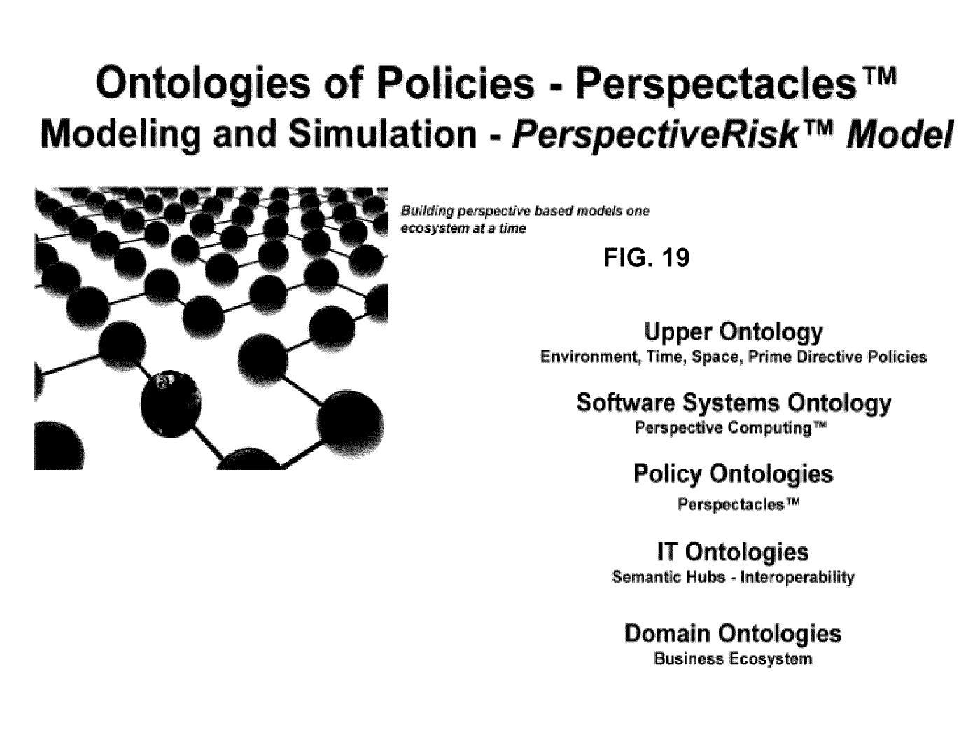

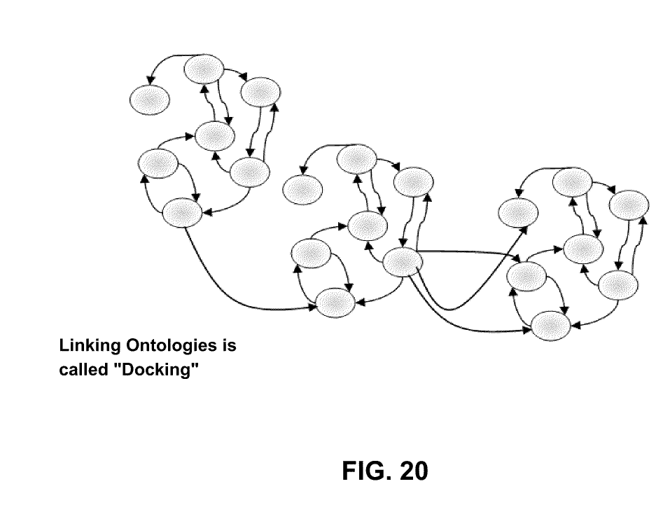

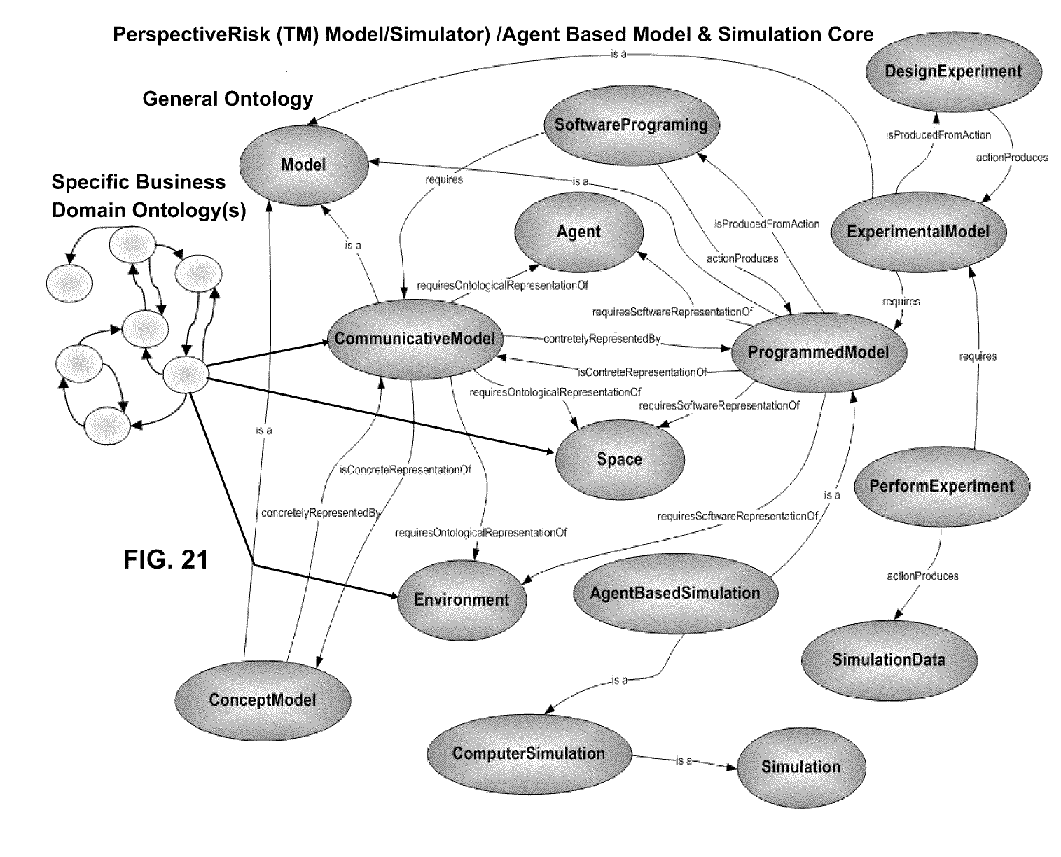

FIG. 8 is a simplified domain ontology that shows the properties of the Class Msg1. the Properties of interest for Data Provenance are contained in Msg1. of the Business Object that is acted upon when a message is received. Data Provenance is enabled by establishment of the relationships in the ontology. As can be visualized in from these diagrams, relationships between the message(s) (What event), Data Provenance concept(s), and the resource(s) of a set of business objects is essential to be able to:
1) audit all Data Provenance actions record, destroy and query using a varying set of filters; date time, URI, Data Provenance action, etc.
2) Query appropriate Data Provenance information based on the resource URI.
3) Rules (policy) accessing the correct Data Provenance information for querying or determining a Quality Aggregate.

Data Provenance Policy Governance

The three actions, record, delete and query, for Data Provenance will be governed by

Data Provenance Immutable Log

All Data Provenance actions will be logged such that the queries, modifications, creations, deletions, etc. can be audited and associated with the What event.

Query Data Provenance Information

Data Provenance information can be queried based on policy.

Data Provenance Genealogy

Data Provenance Genealogy, is the use of Data Provenance information to trace the genealogy of information as it is combined with other information to create a new information resource.

FIG. 50 shows resource database C being created on June 17^{th}. It consists of information from database A and B. Database resource A was last modified on Jun. 10, 2008 whereas database resource B was created on Feb. 4, 2005 and not updated since.

The Quality for database resource C is a simple aggregate algorithm taking the average of the Quality ratings for A and B (10+8/2). The Genealogy concept for database resource C shows it consists of two other resources, cdps.biz.org\dp\dbA and cdps.biz.org\dp\dbB.

FIG. 50 shows a 2^{nd} generation of a combination of resources A and B. Resource C can be used to create another resource, say D. D's genealogy will only point back to C as C's genealogy points back to A and B.

When using multi-generational Data Provenance, discretion must be used to understand how the information from previous generations is used in subsequent generations. The ontology and policy must be used to control the Genealogy concept to ensure the generational information is to be used.

Data Provenance Archive

Data Provenance Archive removes information from a “transactional data provenance store” to a “historical data provenance store”. This will prevent the archived information from being accessed by transactional based events. The archived data provenance information will require access by the auditor.

Data Provenance Source

Data Provenance information can be accessed through data contained within a message (event). However, there will be occurrences when this is not achievable. For instance, in another example, the database resource B is never accessed via CCA. Its data provenance information will require the its information to be stored in the Data Provenance information via a mechanism, for instance defined in the Data Provenance Access control below.

Data Provenance Access Control

The controlling mechanism for Data Provenance is CCA Data Provenance Service, CDPS. The CCA Application Service must not be able to directly control the actions taken by CDPS in cleating, updating, or deleting Data Provenance information. In another example, this is required to keep the (polity of Data Provenance information high and secure from application tampering.)

In one embodiment, the present invention provides continuous over-the-horizon systemic situation awareness to members of complex financial networks or any other dynamic business ecosystem. In one specific embodiment, the present invention is based on semantic technologies relating to complex interdependent risks affecting network of entities and relationships to expose risks and externalities that may not be anticipated, but must be detected and managed to exploit opportunity, minimize damage, and strengthen the system. The present invention may be applied to a policy that is typically described as a deliberate plan of action to guide decisions and achieve rational outcome(s). In one example, policies may vary widely according to the organization and the context in which they are made. Broadly, policies are typically instituted in order to avoid some negative effect that has been noticed in the organization, or to seek some positive benefit. However policies frequently have side effects or unintended consequences. The present invention applies to these polices including participant roles, privileges, obligations, etc.

In another embodiment, the present invention is used to map these requirements across the web of entities and relationships. In one example, not everyone can see everything, but everyone can see everything they and their counterparties, for instance, agree they need to see; or that regulators deem is required. Transparency is enhanced and complexity is reduced when everyone gets to see what is actually happening across their network as it grows, shrinks, and evolves over time.

In another embodiment, the present invention relates to data provenance. In one aspect, data provenance refers to the history of data including its origin, key events that occur over the course of its lifecycle, and other traceability related information associated with its creation, processing, and archiving. This includes concepts such as:

What (sequence of resource lifetime events).

Who generated the event (person/organization).

Where the event came from (location).

How the event transformed the resource, the assumptions made in generating it, and the processes used to modify it.

When the event occurred (started/ended), Quality measure(s) (used as a general quality assessment to assist in assessing this information within the policy governance). Genealogy (defines sources used to create a resource).

In another embodiment, the data quality of the data provenance can be used via policy to estimate data quality and data reliability based on the (Who, Where) source of the information and the process. (What, How) used to transform the information. In yet another embodiment, the audit trail of the data provenance can be used to trace the audit trail of data, and determine resource usage, who has accessed information. The audit trail can be used when establishing patents, or tracing intellectual property for business or legal reasons. In yet another embodiment, the attribution of the data provenance can be applied: pedigree can establish the copyright and ownership of data, enable its citation, and determine liability in the case of erroneous use of data. In vet another embodiment, the informational of the data provenance can be applied: a generic use of data provenance lineage is to query based on lineage metadata for data discovery. It can be browsed to provide a context to interpret data.

In another embodiment, the present invention can be applied as a means of assessing relative effectiveness of alternate policies intended to produce or influence specific behaviors in objects such as:

Policies Includes Data and Information Products Events;

Including Transactions, Processes;

Including Business Processes, Persons;

Individual or Corporate, States of Affairs Enables;

In a further embodiment, the present invention applies to semantic technologies capabilities such as sense, discover, recognize, extract information, encode metadata. As such, the present invention builds in flexibility and adaptability—such as easy to add, subtract, and change components because changes impact the ontology layer, with far less coding involved. Encode meanings and relationships separately from data and content files and application code. In another embodiment, the present invention can organize meanings using taxonomies and ontologies; reason via associations, logic, constraints, rules, conditions and axioms. In yet another embodiment, the present invention uses ontologies instead of a database.

Suitable examples of application of the present invention may include, but are not limited to, one or more of the following: as an intelligent search “index”, as a classification system, to hold business rules, to integrate DB with disparate schemas, to drive dynamic & personalized user interface, to mediate between different systems, as a metadata registry, formal representation of how to represent concepts of business and interrelationship in ways to facilitate machine reasoning and inference, logically maps information sources and describes interaction of data, processes, rules and messages across systems.

### Example

The following is an illustrative example of the present invention in the application where an enterprise and individuals needs the capacity to measure precisely the risks associated with all sorts of assets (physical and financial) as they move, evolve and change hands, like geospatial data or financial data. As such, the enterprise must keep track, secure and price assets adequately and continuously over time. This example is shown to demonstrate how the present invention can be applied to solve “real world” problems and is not meant to limit the present invention.

In one embodiment, the present invention can be used to create an independently repeatable model and corresponding systems technology capable of recreating the risk characteristics of any assets at any time. This example is also shown in the accompanying Figures.

In another embodiment, the present invention employs variables that are independent of the actual data and are support independent indexing and searching. For example, s further shown by the corresponding Figures, the present invention can codify policies into four categories. A—Actors (of humans, machines, events, etc.). B—Behaviors. C—Conditions. D—(Degrees) Measures (measurable results).

In yet another embodiment, illustrated by the accompanying Figures, the present invention relates to resource oriented architecture. Resource is an abstract entity that represents information. Resources may reside in an address space: {scheme}:{scheme-dependent-address}, where scheme-names can include http, file, ftp, etc. In one example, requests are usually stateless. Logical requests for information are isolated from physical implementation.

### Example

### Liquid Trust

The following is an example of the present invention in the application of a mortgage hack securities (“MBS”). The present invention produces a “liquid trust” (“LT”)—these are synthetic derivative instruments constructed from data about “real” MBS that currently exist on an individual bank\'s balance sheet or on several banks' balance sheets. The present invention applies expert perspectives of MBS SME that are captured in LT Perspectacles to define the specific data attributes to use to define the LT MBS. Each LT SME's Perspectacles is that SME's personal IP. The present invention tracks that IP and the business processes associated with it across all subsequent generations of derivative MBS and other instruments that use or reference that SME's original Perspectacles.

In one specific example, the present invention can assure Steve Thomas, Bloxom, ABANA and Heshem, Unicorn Bank, other Islamic and US/UK banks, Cisco, as well other Participant Observers and Tier I contributors that their IP contributions will be referenced bat ALL subsequent PC/LT Debt Default derivative instrument trading, auditing, accounting, regulatory applications.
(a) All the SME/PO. And other original contributors get fractional basis point participation in all trades of the resulting LT MBS
(b) They also get fractional basis point participation in all the regulatory, IP, and trade process policy audit transaction fees.

In another example, the banks that own the original MBS would provide the data needed to create the LT derivative MBS because the present invention can do this without compromising or revealing the names of the banks whose inventory of scrap MBS the present invention is using to forge new LT True Performance MBSs from. This means that they are shielded from negative valuation fallout from anyone knowing how much scrap they have on their sheets. This means that they are put in an excellent position to benefit as their balance sheets are improved by fees from trade and audit transactions on the LT derivative MBSMeans they will have strong incentive to KEEP the real MBS on their balance sheet (thus ending that on-off balance sheet problem once and for all.) This means USG Regulators can audit improvements of bank balance sheets, without compromising knowledge of how much ‘real’ MBBS inventory any given bank has.

As a result, the trades of the synthetic LY MBS reduces uncertainty about the value of the underlying real MBS by providing a continuously auditable basis for tracking the quality of the risk and value of the underlying MBS (via the data attributes we continuously monitor and audit). This continuous audit of the quality of the data that the present invention uses to define the synthetic LT MBS provides a solid and continuously and independently verifiable basis for evaluating risk, value and quality of both the real and the LT derivative MBS. It also can generate several tiers of date quality audit transaction fees. In addition, it can also achieve one or more of the following: a) same for risk assessment business process integrity audit transition fees; b) same for third party validation/verification fees; c) same of regulatory audit fees.

In a further embodiment, the banks will get paid fractional basis points of the value of each LT derivative MBS that is derived from a real MBS that is on their balance sheets and thus, can directly improves that balance sheet. In addition, it can also achieve one or more of the following: a) the banks make a fractional basis point fee on each trade and each audit related to each trade; b) the banks make fractional basis point fees from the ongoing management, regulatory compliance audits associated with managing the funds and the LTMBS trades; c) the banks will often be owned in large part by one or more Sovereign Wealth funds that have an interest in seeing the toxic MBS converted to valuable raw material for the ongoing construction of new, high performance LT derivative MBSs.

In a further embodiment, the present invention creates an Index based on the price, value, spreads and other attributes of the LiquidTrust MBSs and various attributes related to the ‘real’MBSs. As such, the present invention can create ‘funds’ made up of LT synthetic MBS that share various geographic, risk profile, religious, ethnic, or other characteristics. (if we wanted to we could have funds with named beneficiaries (a public school district, a local church/synagogue/mosque, a retirement fund, etc. . . . ). In yet another embodiment, the present invention develops several template risk management investment strategies. One template example shows how the present invention can use the DM-ROM to establish a specific path to a specific objective that our risk management investments are intended achieve. This reinforces that all investments are risk management investments of one type or another and, if viewed that way, can benefit from our approach.

In yet another embodiment, the present invention can define milestones along the “path”: some are time and process drive milestones; and/or others are event driven. As these milestones

are reached, the present invention can manually and automatically review and reevaluate the next phase of investment. This is designed in part to show the value of continuous evaluation of the quality of the data that underpin the risk assessment effectiveness and the effectiveness and efficiency of the risk management investments (which are actualized risk management policies). In one example, the present invention can: show how an alert can be sent to various policy and investment stakeholders as investment strategy reevaluation milestones are reached; show how they can be automatically evaluated and various alternative next phase strategies triggered depending on changes in data quality underpinning risk assessments, deteriorating value of the derivative, increased quality of the data that shows the value of the derivative is actually worse that originally thought, better than originally thought, etc. The point is that the present invention can anticipate all sorts of potential states of affairs and the continuous situation awareness monitoring capability of Liquid

In yet another embodiment, the present invention can highlight the value PC's continuous data quality assurance brings to Real Options, and all other models, including the Impact data default risk model. PC's risk assessment continuously tests the data quality against dynamically changing metrics defined by stakeholders and the present invention can continuously test the effectiveness of the assumptions of the models.

In a further embodiment, the present invention can tranche the risk of the LT MBS based on Impact data risk assessments (e.g. also audited and generate fees for all stakeholders). Trades are made on the LT MBS—they will be long and short. CDS are constructed to hedge the LY MBS Trade positions. The banks can set up the ETFs to trade the LT derivative MBS and the CDS associated with each trade.

What is claimed is:

1. A system for measurement and verification of data related to at least one financial derivative instrument, wherein the data related to the at least one financial derivative instrument is associated with at least a first financial institution and a second financial institution, and wherein the first financial institution and the second financial institution are different from one another, comprising:
at least one computer; and
at least one database associated with the at least one computer, wherein the at least one
database stores data relating to at least: (a) a first quality of the data metric related to the at least one financial derivative instrument, wherein the first quality of data metric is associated with the first financial institution; and (b) a second quality of the data metric related to the at least one financial derivative instrument, wherein the second quality of data metric is associated with the second financial institution;
wherein the at least one computer is in operative communication with the at least one database; and
wherein the at least one computer and the at least one database cooperate to dynamically map a change of the quality of the data, as reflected in at least the first data metric and the second data metric.

2. The system of claim 1, wherein the measurement and verification of data relates to a plurality of financial derivative instruments.

3. The system of claim 1, wherein the financial derivative instrument is a financial instrument that is derived from some other asset, index, event, value or condition.

4. The system of claim 1, wherein each of the first and second financial institutions is selected from the group consisting of: (a) bank; (b) credit union; (c) hedge fund; (d) brokerage firm; (e) asset management firm; (f) insurance company.

5. The system of claim 1, wherein a plurality of computers are in operative communication with the at least one database.

6. The system of claim 1, wherein the at least one computer is in operative communication with a plurality of databases.

7. The system of claim 1, wherein a plurality of computers are in operative communication with a plurality of databases.

8. The system of claim 1, wherein the at least one computer is a server computer.

9. The system of claim 1, wherein the dynamically mapping is carried out essentially continuously.

10. The system of claim 1, wherein the dynamically mapping is carried out essentially in real-time.

11. The system of claim 1, further comprising at least one software application.

12. The system of claim 11, wherein the at least one software application operatively communicates with the at least one computer.

13. The system of claim 12, wherein the at least one software application is installed on the at least one computer.

14. The system of claim 11, wherein the at least one software application operatively communicates with the at least one database.
